(19) United States
(12) Patent Application Publication
(10) Pub. No.: US 2026/0352986 A1
(43) Pub. Date: Nov. 5, 2026

(54) COMMUNICATION SYSTEM AND NORMALCY JUDGMENT METHOD

(71) Applicant: NTT, Inc., Tokyo (JP)

(72) Inventors: Manabu YOSHINO, Musashino-shi (JP); Kazutaka HARA, Musashino-shi (JP); Shin KANEKO, Musashino-shi (JP)

(73) Assignee: NTT, Inc., Tokyo (JP)

(21) Appl. No.: 19/100,092

(22) PCT Filed: Aug. 4, 2022
(86) PCT No.: PCT/JP2022/029952

§ 371 Date: Jan. 30, 2025

(51) Int. Cl. H04Q 11/00

(52) U.S. Cl. CPC H04Q 11/0071; H04Q 2011/0073; H04Q 2011/0083; H04Q 2213/003

(57) ABSTRACT

A communication system includes: an optical switch provided in a signal path connecting a first communication device to a second communication device;
a splitting/switching unit disposed outside of the optical switch, configured to split or switch an optical signal transmitted from the first communication device and passed via the optical switch, configured to split the optical signal to the second communication device and the control unit when the optical signal is split, and configured to be switched toward the second communication device or the control unit when the optical signal is switched;
and the control unit configured to terminate the optical signal from the splitting/switching unit and execute transmission confirmation of the signal path.

### TECHNICAL FIELD

With the spread of the Internet of things (IOT) and progress in the digitization of society and industry, an amount of data flowing on the Internet has increased. Additionally, service use cases of a type different from the best-effort type have emerged. For advances in such services, bandwidth guarantees and low delay requirements have been increasing for communication networks. For example, in cyber physical systems, uploading of a large amount of sensing data obtained from the real world (physical spaces) to information processing infrastructures (cyber spaces) in real time without loss, feedback of control information to the real world with high reliability and low delay, transmission of high definition images, and the like are required for transport infrastructures. The cyber physical systems are systems that realize optimal control in the real world by analyzing huge amounts of sensing data obtained from the real world on a computer and feeding back analysis results. It can be expected that such cyber physical systems will create new values and solutions.

In view of such a circumstance, an all-photonics network (APN) based on a photonics technology has been studied as a network of a new architecture for accommodating traffic requiring a large capacity and low delay (see NPL 1). The APN is one of transparent networks for transmitting any user signal. An APN provides an end-to-end optical path independently of a specific communication protocol and an optical modulation scheme.

### CITATION LIST

### Non Patent Literature

NPL 1: Shin Kaneko, Kazutaka Hara, Junichi Kani, Takeshi Seki, Hiroki Kawahara, Takashi Miyamura, Hideki Maeda, “Special Edition 2-10 2. New evolution of ICT supporting super-smart society Novel system architecture toward the realization of all-photonics network of”, the Journal of the Institute of Electronics, Information and Communication Engineers, Vol. 104, No. 5, pp. 471 to 477, May 2021

### SUMMARY OF INVENTION

### Technical Problem

However, a scheme for determining normality (confirming transmission) of paths of optical signals for transmitting main signals of various protocols transparently in an APN has not yet been established. Hereinafter, determination of normality of a path of an optical signal is referred to as “signal path normality determination”. For example, when communication error occurs, a transmission path of an optical signal is sectioned and signal path normality determination (normality monitoring) is executed for each section in order to identify an occurrence point of the error.

In the signal path normality determination for each section, transmission of the optical signal is confirmed from one section to the other section of target sections of the signal path normality determination. Here, in the transmission confirmation, at an endpoint of a target section of signal path normality determination, at least some of optical signals and termination are subjected to optical electrical conversion (hereinafter referred to as “OE conversion”) and determined by termination, or determined using a nonlinear optical effect or the like related to the optical signals. Here, the use of the nonlinear optical effect or the like is to use a gain in a gain medium or a light absorption medium, a change in a current or a voltage applied to the medium, pump light input to the medium, an intensity change of gain clamp light after passing through the medium, a change in light generated by a nonlinear optical effect such as idler light, and the like.

In the signal path normality determination, a loop-back scheme is mainly used in response to a request from one of target sections and loop-back a response from the other section. In loopback of an optical signal, the optical signal of a request is transmitted to one endpoint or ahead of a target section of optical signal path normality determination. In OE conversion for reception of a response, optical-electrical-optical conversion (hereinafter referred to as “OEO conversion”) is required at a return point of an optical signal loop-back a response corresponding to the request at the other endpoint or ahead of the other endpoint.

In the case of a communication network of the related art, the signal path normality determination can be executed through the OE conversion by a relay device at each transmission section. Accordingly, in the case of the communication network of the related art, there is no transmission section in which the signal path normality determination cannot be executed.

On the other hand, the APN is a transparent network that transmits light not subjected to the OE conversion and does not execute the OE conversion of a main signal in the relay device. Therefore, in order to execute the signal path normality determination, it is necessary to provide an optical switch at least at one endpoint of the section to be confirmed, switch a path from the signal path, and execute the OE conversion and confirm normality. Therefore, the APN has a problem that it is not possible to execute the signal path normality determination for a transmission section inside the optical switch used for switching.

Specifically, as illustrated in FIG. 11, in the APN, when the signal path normality determination is executed, the signal path of the main signal is switched in the optical switch, it is necessary to transmit an optical signal to a transceiver (for example, an “access network management control unit” in FIG. 11) that executes the OE conversion. However, as illustrated in FIGS. 12 and 13, when an original signal path connecting user devices is switched to a signal path connecting the user devices to the access network management control unit in the optical switch, a transmission section inside the optical switch indicated by a broken line among original signal paths before the switching is not a signal path. Therefore, there is a problem that the signal path normality determination on the transmission section cannot be executed.

The present invention has been devised in view of the technical background as described above, and an object of the present invention is to provide a technology capable of preventing occurrence of a transmission section in which signal path normality determination cannot be executed inside an optical switch in signal path normality determination.

### Solution to Problem

An embodiment of the present invention is a communication system including: an optical switch provided in a signal path connecting a first communication device and a second communication device; a splitting/switching unit disposed outside of the optical switch, configured to split or switch an optical signal transmitted from the first communication device and passed via the optical switch, by splitting the optical signal to the second communication device and the control unit when split or by switching toward the second communication device or the control unit when switch; and the control unit configured to terminate the optical signal from the splitting/switching unit and confirm transmission of the signal path.

An embodiment of the present invention is a communication system including: an optical switch provided in a signal path connecting a first communication device and a second communication device;
a switching unit configured to switch the signal path so that a second user device is disconnected from the signal path and an optical signal transmitted from the first communication device and passed via the optical switch is transmitted to a control unit when transmission of the signal path is confirmed; and the control unit configured to terminate the optical signal transmitted by switching the signal path and confirm transmission of the signal path.

An embodiment of the present invention is a communication system including: an optical switch provided in a signal path connecting a first communication device and a second communication device, configured to switch an output destination of a signal by modify a path, for transmitting an internal signal, of which one side is fixed to an input/output ports of the switch and the other side is switched to connect to input/output ports of the switch; and a control unit configured to modify the signal paths, terminate the optical signals transmitted and confirm transmission of the both signal paths by modifying the signal path, inside the optical switch, of which one side is fixed to an input/output port connected to the first communication device so that an optical signal transmitted from the first communication device is transmitted toward the control unit and by modifying the signal path, inside the optical switch, of which one side is fixed to the input/output port connected to the control unit so that an optical signal transmitted from the second communication device is transmitted toward the control unit, when transmission of the signal path is confirmed.

An embodiment of the present invention is a communication system including: an optical switch provided in a signal path connecting a first communication device and a second communication device, including a connection point inside the switch, and configured to connect the connection point to an input/output port of the switch; and a control unit configured to terminate the optical signal transmitted by the switching and confirm transmission of signal paths of both sides by keeping connection of an inside connection point from the first communication device and connecting the path from the connection point to the control unit so that an optical signal transmitted from the first communication device is transmitted to the control unit or by keeping connection of an inside connection point from the second communication device and connecting the path from the connection point to the control unit so that an optical signal transmitted from the second communication device is transmitted to the control unit, when transmission of the signal path is confirmed.

An embodiment of the present invention is a communication system including: an optical switch provided in a signal path connecting a first communication device to a second communication device; and a control unit configured to switch a reflection direction of the optical signal at an inside reflection point of the optical switch, terminate the optical signal transmitted by the switching of the reflection direction and confirm transmission of the signal paths of both sides by keeping connection of an inside reflection point from the first communication device so that an optical signal transmitted from the first communication device is transmitted to the control unit so that reflection from the reflection point is connected to the control unit, or by keeping connection of an inside reflection point from the second communication device so that reflection from the reflection point is connected to the control unit or an optical signal transmitted from the second communication device is transmitted to the control unit so that reflection from the reflection point is connected to the control unit, when transmission of the signal path on both sides is confirmed.

An embodiment of the present invention is a communication system including: an optical switch including a monitoring unit provided in a signal path connecting a first communication device to a second communication device and confirming transmission of the signal path inside the communication device and configured to switch the signal path so that an optical signal transmitted from the first communication device is transmitted toward a control unit; and the control unit configured to terminate the optical signal transmitted from the optical switch and execute transmission confirmation of the signal path, when transmission confirmation is executed.

An embodiment of the present invention is a normality determination method(a normalcy judgement method) including: a splitting/switching step of splitting or switching an optical signal transmitted from a first communication device and passed via an optical switch by a splitting/switching unit disposed outside of the optical switch provided in a signal path connecting the first communication device or a second communication device, wherein splitting the optical signal to the second communication device and a control unit when splitting and switching the optical signal to the second communication device to the control unit when switching; and a control step of terminating the optical signal from the splitting/switching unit and confirm transmission of the signal path.

### Advantageous Effects of Invention

According to the present invention, it is possible to prevent occurrence of a transmission section in which signal path normality determination cannot be executed inside an optical switch in signal path normality determination.

### BRIEF DESCRIPTION OF DRAWINGS

FIG. 1 is a block diagram illustrating a configuration of a communication system 1 according to a first embodiment of the present invention.

FIG. 2 is a diagram illustrating a configuration of signal path normality determination by the communication system 1 according to the first embodiment of the present invention.

FIG. 3 is a flowchart illustrating an operation of the communication system 1 according to the first embodiment of the present invention.

FIG. 4 is a flowchart illustrating an operation of the communication system 1 according to the first embodiment of the present invention.

FIG. 5 is a diagram illustrating a configuration of signal path normality determination by a communication system according to a second embodiment of the present invention.

FIG. 6 is a diagram illustrating a configuration of signal path normality determination by a communication system according to a third embodiment of the present invention.

FIG. 7 is a diagram illustrating details of a configuration of signal path normality determination by the communication system according to the third embodiment of the present invention.

FIG. 8 is a diagram illustrating a configuration of signal path normality determination by a communication system according to a fourth embodiment of the present invention.

FIG. 9 is a diagram illustrating details of a configuration of signal path normality determination by the communication system according to the fourth embodiment of the present invention.

FIG. 10 is a diagram illustrating a configuration of signal path normality determination by a communication system according to a fifth embodiment of the present invention.

FIG. 11 is a block diagram illustrating a configuration of a communication system of the related art.

FIG. 12 is a diagram illustrating a configuration of signal path normality determination by the communication system of the related art.

FIG. 13 is a diagram illustrating a configuration of signal path normality determination by the communication system of the related art.

### DESCRIPTION OF EMBODIMENTS

### First Embodiment

Hereinafter, a communication system and a normalcy judgement method according to a first embodiment of the present invention will be described with reference to the drawings.

(Communication Network as Comparative Example with APN)

An architecture of a communication network as a comparative example is an architecture for hierarchically connecting access, metro and a core network. When traffic is passed from the access to the metro beyond a boundary between the access and the metro, an optical signal is temporarily converted into an electrical signal at the boundary. Similarly, when traffic is passed from the metro to the core network beyond a boundary between the metro and the core network, the optical signal is temporarily converted into an electrical signal at the boundary. In a communication network as a comparative example, an optical signal (optical path) with a broader bandwidth is aggregated and multiplexed to carry more users and services.

In such a communication network, facilities can be shared between users and between services, which achieves economization. On the other hand, the path bandwidth per user and service is restricted. Therefore, when large capacity data such as a high definition image is transmitted, data compression processing is required, and thus a large amount of delay occurs. Aggregation and multiplexing of electrical signals result in generation of delay and jitter due to waiting processing of packets or frames.

### (Basic Configuration Example of APN)

On the other hand, since a flat architecture is adopted in an APN, the electrical termination of an optical signal provided between layers in a communication network as a comparative example with the APN is not required. In the APN, delay is very small due to end-to-end optical path connection. The APN also has high flexibility and expandability that can easily provide a large capacity and low delay communication network by function without depending on a specific communication protocol.

The APN includes two types of optical nodes including a photonic exchange (hereinafter referred to as a “Ph-EX”) and a photonic gateway (hereinafter referred to as a “Ph-GW” and simply referred to as a “gateway”) as optical nodes that minimize electrical processing such as exchanging, multiplexing, and switching. A Ph-GW is connected to a full mesh. A Ph-GW is an optical node that is located at an entrance of a full mesh network and accommodates various user devices. The full mesh is a connection form in which all elements included in a communication network are directly connected individually. A Ph-EX is an optical node that provides an enormous number of optical paths. These enormous number of optical paths transparently cross an optical backbone network.

With such a configuration, the APN can directly connect points at which any user devices are installed by optical signals without executing electrical processing. Large capacity and low delay communication can be realized by dedicated wavelength allocation to users or services. In the APN, various services can be provided by flexibly combining service function processing necessary at necessary points. The APN can provide a communication environment irrespective of a service type, a protocol, an optical wavelength, and the like.

In order to realize end-to-end direct optical coupling and service function processing at necessary points, a Ph-GW has five basic functions exemplified below.

A first basic function is a function of determining which wavelength is used by a user device and remotely setting wavelength information in the user device. In order to open an end-to-end optical path, a function of assigning a wavelength to each optical path so that the wavelength of an optical signal between optical paths sharing a transmission medium (optical fiber or the like) in an APN is required for the Ph-GW. A function of remotely setting wavelength information of an optical signal of a user device that is an endpoint of an optical path is required for the Ph-GW.

A second basic function is a function of stopping an unnecessary signal caused due to erroneous setting of wavelength information to the user device by communicating an optical signal between a port on an access network side and a port on a full mesh network side in accordance with opening of an optical path. Here, the access network is a network between the Ph-GW and a user device, and the full mesh network is a network between gateways or a network formed by the Ph-GW and the Ph-EX. The Ph-GW transmits (cross-connects), as light, an optical signal input from an access network to an access network, transmits an optical signal input from an access network to a full mesh network, transmits an optical signal input from a full mesh network to an access network, and transmits an optical signal input from a full mesh network to a full mesh network in accordance with a destination.

A third basic function is a function of aggregating and distributing an optical path in which a transmission medium is shared in a full mesh network.

A fourth basic function is a turn-back function of optically directly coupling user devices accommodated in the same Ph-GW to each other. The direct optical coupling is realized in a shortest path by enabling turning back at the Ph-GW located at an entrance of a full mesh network rather than turn-back to an upper optical node.

A fifth basic function is a function for extraction and insertion. In order to reproduce and relay an optical signal from the viewpoint of transmitting an optical signal and execute service function processing, the function for extraction and insertion enables electrical processing at a position of the Ph-GW.

### [Configuration of Communication System]

Hereinafter, a configuration of a communication system according to the first embodiment will be described. Hereinafter, description will be first made using the coupling/splitting unit 400. The coupling/splitting unit 400 may be replaced with an optical switch. When the optical switch is used, the optical switch selects a side for transmitting a main signal, for example, a signal path connecting a user device 300-1 to a user device 300-2 may be used in the case of transmission of the main signal and the signal path may be switched to a signal path connecting the access network management control unit 103-4 to the user device 300-1 in the case of confirmation of the transmission.

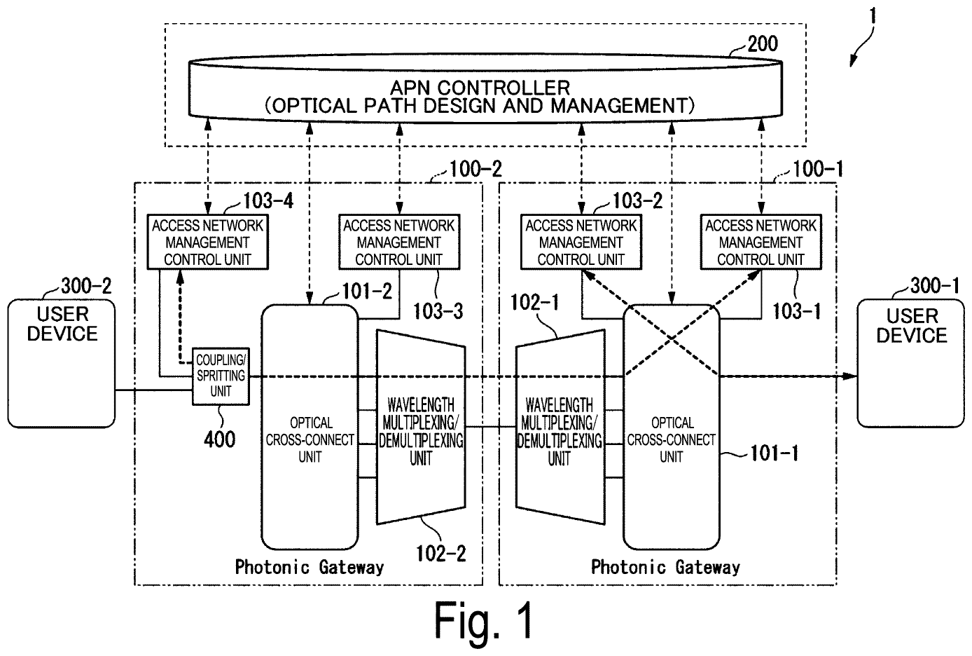

FIG. 1 is a block diagram illustrating a configuration of a communication system 1 according to the first embodiment of the present invention. As illustrated in FIG. 1, the communication system 1 includes a Ph-GW 100-1, a Ph-GW 100-2, an APN controller 200, a user device 300-1, a user device 300-2 and the coupling/splitting unit 400. In order to simplify the drawing, only two Ph-GWs and two user devices are illustrated in FIG. 1. In an actual communication system, however, it is assumed that many Ph-GWs and many devices are arranged, and the Ph-EX is interposed between the Ph-GW and the Ph-GW, and a user device is interposed only through a single Ph-GW.

In FIG. 1, the Ph-GW 100-2 on the left side is illustrated as a Ph-GW that has characteristics including the coupling/splitting unit 400 according to the present invention. The coupling/splitting unit 400 includes, for example, an optical splitter.

The coupling/splitting unit 400 is an example of a splitting/switching unit according to the claims of the present application. For example, the coupling/splitting unit 400 may be a switching unit that switches a signal path depending on an occasion instead of splitting a signal path. In this case, the switching unit includes, for example, an optical switch. The coupling/splitting unit 400 may have a configuration capable of selecting either one or both of splitting and switching. In the following description, the coupling/splitting unit 400 will be described mainly as a splitting unit, but the coupling/splitting unit 400 may be a switching unit or a splitting/switching unit.

On the other hand, the Ph-GW 100-1 on the right side indicates the Ph-GW as a comparative example. Accordingly, in the Ph-GW 100-2 on the left side, when normality of a section between the Ph-GW 100-2 and the Ph-GW 100-1 and a section between the user device 300-2 and the Ph-GW 100-2 is determined, an unmonitored section where signal path normality determination (hereinafter also referred to as “transmission confirmation”) including the signal path inside the optical cross-connect unit 101-2 cannot be executed can be eliminated, but an unmonitored section is generated in the Ph-GW 100-1 on the right side. In the Ph-GW 100-2 on the right side, when normality of a section between the Ph-GW 100-2 and the Ph-GW 100-1 and a section between the user device 300-1 and the Ph-GW 100-1 is determined, a signal path inside the optical cross-connect unit 101-1 becomes an unmonitored section. When a section of normality determination is set to be a section between the user device 300-2 and the Ph-GW 100-2 or between the Ph-GW 100-2 and the user device 300-1, an unmonitored section of the optical cross-connect unit 100-1 on the side on which the coupling/splitting unit 400 is not included is eliminated. Further, by configuring the Ph-GW 100-1 on the right side similarly to the Ph-GW 100-2 on the left side, an unmonitored section can be eliminated for all signal paths between the user devices 300-1 and 300-2.

The Ph-GW 100-1 includes an optical cross-connect unit 101-1, a wavelength multiplexing/demultiplexing unit 102-1, an access network management control unit 103-1, and an access network management control unit 103-2. The Ph-GW 100-2 includes an optical cross-connect unit 101-2, a wavelength multiplexing/demultiplexing unit 102-2, an access network management control unit 103-3, and an access network management control unit 103-4.

In the present embodiment, for example, the Ph-GW 100-1 includes the wavelength multiplexing/demultiplexing unit 102-1 and the Ph-GW 100-2 includes the wavelength multiplexing/demultiplexing unit 102-2. In the present embodiment, for example, a signal path between the user device 300-1 and the user device 300-2 is configured to pass through the wavelength multiplexing/demultiplexing unit 102-1 and the wavelength multiplexing/demultiplexing unit 102-2. However, the present invention is not limited to such a configuration, but a case in which a signal path does not pass through the wavelength multiplexing/demultiplexing unit, or a case in which the Ph-GW does not originally include the wavelength multiplexing/demultiplexing unit is conceivable.

The optical cross-connect units 101-1 and 101-2 transmit (cross-connect) optical signals input from an access network and a full mesh network as light depending on a destination. Thus, the optical cross-connect units 101-1 and 101-2 realize a turn-back function (the foregoing fourth basic function) for directly coupling light.

The optical cross-connect units 101-1 and 101-2 realize a turn-back function (the foregoing fourth basic function) for optically directly coupling the user devices 300 accommodated in the same Ph-GW 100 to each other. The optical cross-connect units 101-1 and 101-2 realize optical add/drop to an electrical processing unit (not illustrated) (the foregoing fifth basic function).

When a loopback signal is transmitted and received by an access network management control unit 103-2 of the Ph-GW 100-2, for example, normality of paths between the access network management control unit 103-2, the optical cross-connect unit 101-2, the user device 300-2, the optical cross-connect unit 101-2, and the access network management control unit 103-2 is confirmed.

When a loopback signal is transmitted and received by the access network management control unit 103-2 of the Ph-GW 100-2, for example, normality of paths between the access network management control unit 103-2, the optical cross-connect unit 101-2, a turn-back unit (not illustrated) or a reflection/transmission unit (not illustrated) on the left side of the optical cross-connect unit 101-2, the optical cross-connect unit 101-2, the wavelength multiplexing/demultiplexing unit 102-2, a transmission line between gateways, the wavelength multiplexing/demultiplexing unit 102-1, the optical cross-connect unit 101-1, the user device 300-1, the optical cross-connect unit 101-1, the wavelength multiplexing/demultiplexing unit 102-1, the wavelength multiplexing/demultiplexing unit 102-2, a turn-back unit (not illustrated) or a reflection/transmission unit (not illustrated) on the left side of the optical cross-connect unit 101-2, the wavelength multiplexing/demultiplexing unit 102-2, and the access network management control unit 103-2 may be confirmed.

When a loopback signal is transmitted and received by the access network management control unit 103-2 of the Ph-GW 100-2, for example, normality of paths between the access network management control unit 103-2, the optical cross-connect unit 101-2, a turn-back unit (not illustrated) or a reflection/transmission unit (not illustrated) on the left side of the optical cross-connect unit 101-2, the optical cross-connect unit 101-2, the wavelength multiplexing/demultiplexing unit 102-2, a transmission line between gateways, the wavelength multiplexing/demultiplexing unit 102-1, the optical cross-connect unit 101-1, a turn-back unit (not illustrated) or a reflection/transmission unit (not illustrated) on the right side of the optical cross-connect unit 101-1, the optical cross-connect unit 101-1, the wavelength multiplexing/demultiplexing unit 102-1, a transmission line between gateways, the wavelength multiplexing/demultiplexing unit 102-2, the optical cross-connect unit 101-2, the turn-back unit (not illustrated) or a reflection/transmission unit (not illustrated) on the left side of the optical cross-connect unit 101-2, the optical cross-connect unit 101-2, and the access network management control unit 103-2 may be confirmed.

When a loopback signal is transmitted and received by the access network management control unit 103-1 of the Ph-GW 100-1, for example, normality of paths between the access network management control unit 103-1, the optical cross-connect unit 101-1, the user device 300-1, the optical cross-connect unit 101-1, and the access network management control unit 103-1 is confirmed.

When a loopback signal is transmitted and received by the access network management control unit 103-1 of the Ph-GW 100-1, for example, normality of paths between the access network management control unit 103-1, the optical cross-connect unit 101-1, a turn-back unit (not illustrated) or a reflection/transmission unit (not illustrated) on the left side of the optical cross-connect unit 101-1, the optical cross-connect unit 101-1, the wavelength multiplexing/demultiplexing unit 102-1, a transmission line between gateways, the wavelength multiplexing/demultiplexing unit 102-2, the optical cross-connect unit 101-2, the user device 300-2, the optical cross-connect unit 101-2, the wavelength multiplexing/demultiplexing unit 102-2, the wavelength multiplexing/demultiplexing unit 102-1, a turn-back unit (not illustrated) or a reflection/transmission unit (not illustrated) on the left side of the optical cross-connect unit 101-1, the wavelength multiplexing/demultiplexing unit 102-1 and the access network management control unit 103-1 may be confirmed.

When a loopback signal is transmitted and received by the access network management control unit 103-1 of the Ph-GW 100-1, for example, normality of paths between the access network management control unit 103-1, the optical cross-connect unit 101-1, a turn-back unit (not illustrated) or a reflection/transmission unit (not illustrated) on the left side of the optical cross-connect unit 101-1, the optical cross-connect unit 101-1, the wavelength multiplexing/demultiplexing unit 102-1, a transmission line between gateways, the wavelength multiplexing/demultiplexing unit 102-2, the optical cross-connect unit 101-2, a turn-back unit (not illustrated) or a reflection/transmission unit (not illustrated) on the right side of the optical cross-connect unit 101-2, the optical cross-connect unit 101-2, the wavelength multiplexing/demultiplexing unit 102-2, a transmission line between gateways, the wavelength multiplexing/demultiplexing unit 102-1, the optical cross-connect unit 101-1, a turning-back unit (not illustrated) or a reflection/transmission unit (not illustrated) on the left side of the optical cross-connect unit 101-1, the optical cross-connect unit 101-1, and the access network management control unit 103-1 may be confirmed.

The wavelength multiplexing/demultiplexing unit 102-1 wavelength-multiplexes an optical signal sharing the same path among optical signals output from the optical cross-connect unit 101-1. The wavelength multiplexing/demultiplexing unit 102-1 outputs the wavelength-multiplexed optical signal to a full mesh network. The wavelength multiplexing/demultiplexing unit 102-1 separates the wavelength-multiplexed signal input from the full mesh network in units of wavelengths (the foregoing third basic function).

Similarly, the wavelength multiplexing/demultiplexing unit 102-2 wavelength-multiplexes an optical signal sharing the same path among optical signals output from the optical cross-connect unit 101-2. The wavelength multiplexing/demultiplexing unit 102-2 outputs the wavelength-multiplexed optical signal to a full mesh network. The wavelength multiplexing/demultiplexing unit 102-2 demultiplexes the wavelength-multiplexed signal input from the full mesh network in units of wavelengths (the foregoing third basic function).

The Ph-GW 100 is one of devices (transmission/reception devices) that transmits and receives an optical signal included in the Ph-GW 100. The access network management control unit 103-1 exchanges control information between the access network management control unit 103-1 and the user device 300-1 during initial connection of the user device 300-1. The access network management control unit 103-1 transmits an instruction to set a wavelength to the user device 300-1.

The access network management control unit 103-1 and the access network management control unit 103-2 exchange control information with the user device 300-1 during initial connection of the user device 300-1 and give an instruction to set a wavelength to the user device 300-1. Similarly, the access network management control unit 103-3 exchanges control information with the user device 300-2 during initial connection of the user device 300-2, and instructs the user device 300-2 to set a wavelength (the foregoing first basic function).

In the configuration illustrated in FIG. 1, in order to set a signal path between the user device 300-2 and the access network management control unit 103-4, it is necessary to return the signal path of the optical cross-connect unit 101-2 to a port on the side (right side) of the wavelength multiplexing/demultiplexing unit 102-2.

The access network management control unit 103 may multiplex the control signal to an optical signal of a main signal by time division multiplexing, code division multiplexing, or frequency division multiplexing such as AMCC or may multiplex the control signal to the optical signal of the main signal by intensity multiplexing, phase multiplexing, frequency multiplexing, or polarization multiplexing, instead of multiplexing of an access system optical signal with an optical signal of a main signal by space division multiplexing, polarization division modulation, wavelength division multiplexing, or the like. In this case, instead of multiplexing using a coupling/splitting device, coupling/splitting unit, or the like, a modulator or, an amplifier or an attenuator capable of modulating an amplification factor or an attenuation factor may be used. In description of the present application, a case where a control signal is multiplexed on an optical signal of a main signal will be mainly described, but it is apparent that the control signal can be used when an access system optical signal different from the optical signal of the main signal is multiplexed. When the access system optical signal is multiplexed on a loopback side and an optical transmitter and an optical receiver of the access system optical signal and the main signal are separate, the optical transmitter and the optical receiver of the main signal are out of normality determination. Therefore, it is desirable to loop back between the optical transmitter and the optical receiver or confirm normality by means other than the loop back. Only when the normality of the optical transmitter and the optical receiver of the main signal is confirmed by such a scheme, the normality of the optical transmitter and the optical receiver of the main signal can be notified of by signal loopback if a loopback signal is looped back from the optical transmitter of the access system optical signal. Of course, the optical transmitter and the optical receiver of the main signal, the optical transmitter and the optical receiver of the access system optical signal, and the like may be separately determined and notified.

An APN that supports various social infrastructure networks is required to be able to set an optical path for various user devices so that a dedicated network of a wavelength by function can be easily provided. Therefore, it is necessary to immediately open the optical path only by connecting the user device 300-1 to the user device 300-2 by an optical fiber.

Firstly, the user device 300-1 or 300-2 reports own device information and partner device information to, for example, the nearest Ph-GW. The user device 300-1 or 300-2 may report the own device information and the partner device information to the Ph-GW 100-1 or the Ph-GW 100-2.

The own device information and the partner device information is reported to the nearest Ph-GW 100, but may be reported to the Ph-GW 100 other than the nearest Ph-GW 100. For example, the user device 300-1 or 300-2 may report the own device information and the partner device information to the Ph-GW 100-2 or the Ph-GW 100-1. The latter is suitable, for example, when the connection is restored and information regarding the PhGW connected to a partner device is known. Hereinafter, a case in which the own device information and the partner device information is reported to the nearest Ph-GW will be mainly described.

Secondly, the APN controller 200 executes wavelength resource management and optical path design inside the APN. In response to a report from the user device 300-1 or 300-2, the Ph-GW 100-1 or 100-2 determines a wavelength to be allocated to the user device 300-1 or 300-2 in cooperation with the APN controller 200. The Ph-GW 100-1 or 100-2 notifies the user device 300-1 or 300-2 of the wavelength.

Thirdly, an internal path of the Ph-GW 100-1, an internal path of the Ph-GW 100-2, and an internal path of the Ph-EX are each set. In FIG. 1, the inside path of the Ph-GW 100-1, the inside path of the Ph-GW 100-2, and a path connecting the Ph-GW 100-1 and the Ph-GW 100-2 are set. When the Ph-GW 100-1 and the Ph-GW 100-2 are connected via the Ph-EX (not illustrated), an internal path of the Ph-GW 100-1, a path between the Ph-GW 100-1 and the Ph-EX (not illustrated), an internal path of the Ph-EX (not illustrated), a path between the Ph-EX (not illustrated) and the Ph-GW 100-2, and an internal path of the Ph-GW 100-2 are set.

In the APN, optical signals corresponding to signals of various communication protocols are transmitted from the user devices 300-1 and 300-2. Therefore, a management control scheme independent of the communication protocols is required. As the access system management control scheme, for example, an auxiliary management control channel (AMCC) is used.

### [Transmission Confirmation]

In the APN, the user devices communicate with each other via a Ph-GW which is an intra-station device. When there is communication error, transmission confirmation is executed in each section. As described above, the communication system 1 according to the first embodiment includes the coupling/splitting unit 400 outside of an optical switch (the optical cross-connect unit 101-2). The coupling/splitting unit 400 is, for example, an optical splitter.

In the communication system 1 according to the first embodiment, instead of terminating the light of which the signal path is switched inside the optical switch, the light split by the coupling/splitting unit 400 provided outside of the optical switch is terminated by the optical transceiver (optical TRx) of the user device and section monitoring is executed.

In the communication system 1 exemplified in FIG. 1, the coupling/splitting unit 400 provided outside of the optical cross-connect unit 101-2 splits light transmitted from the user device 300-1 into a path to the user device 300-2 and a path to the access network management control unit 103-4. The coupling/splitting unit 400 multiplexes the light transmitted from the user device 300-2 and the light transmitted from both the access network management control unit 103-4, and transmits the multiplexed light to a path to the user device 300-1. Thus, a signal path between the user devices 300-1 and 300-2 and a signal path between the user device 300-1 and the access network management control unit 103-4 are formed.

The coupling/splitting unit 400 connects both the user device 300-2 and the access network management control unit 103-4 to the optical cross-connect unit 101-2. The coupling/splitting unit 400 splits an output of the optical switch (optical cross-connect unit 101-2) to both the access network management control unit 103-4 and the user device 300-2 and outputs the split the output. The coupling/splitting unit 400 multiplexes outputs of both the access network management control unit 103-4 and the user device 300-2 and outputs them to an optical switch (optical cross-connect unit 101-2).

In an initial setting of the user device 300-2, the optical cross-connect unit 101-2 connects the user device 300-2 to the access network management control unit 103-3 (via the coupling/splitting unit 400) and executes the initial setting. The initial setting may be executed by the access network management control unit 103-1 of the Ph-GW 100-1 which is not near instead of executing the initial setting by the nearby Ph-GW 100-2. Although only the user device 300-2 has been described here, the same applies to the user device 300-1. However, in the configuration illustrated in FIG. 1, the coupling/splitting unit 400 is not provided on the user device 300-1 side. Therefore, when the setting is executed by the nearby Ph-GW 100-1 and the access network management control unit 103-2 executes the setting in the Ph-GW 100-2 which is not near the access network management control unit 103-4 executes the setting via the coupling/splitting unit 400. When the user device 300-2 and the user device 300-1 communicate with each other, the optical switch (the optical cross-connect unit 101-2) connects the user device 300-2 to the user device 300-1 (via the coupling/splitting unit 400).

When transmission from the user device 300-1 to the coupling/splitting unit 400 via a signal path inside the optical switch (optical cross-connect unit 101-2) is confirmed, the optical switch (optical cross-connect unit 101-2) connects a port connected to the signal path to the user device 300-1 and a port connected to the coupling/splitting unit 400, and a signal path in which the user device 300-1 and the access network management control unit 103-4 are connected via the coupling/splitting unit 400 is formed. Thus, the transmission from the user device 300-1 to the coupling/splitting unit 400 via the signal path inside the optical switch (optical cross-connect unit 101-2) can be confirmed.

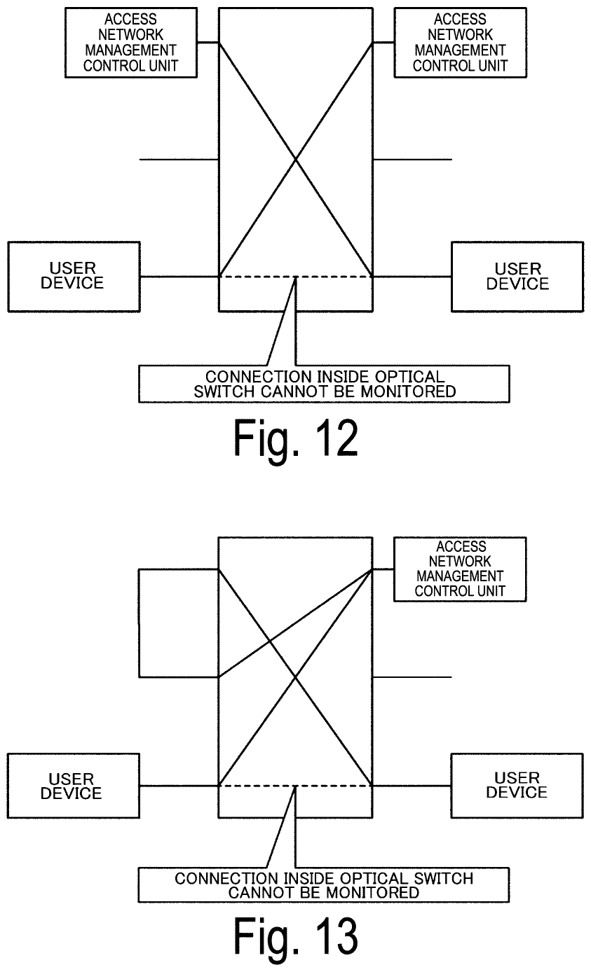

When the transmission from the user device 300-2 to the coupling/splitting unit 400 is confirmed, the optical switch (optical cross-connect unit 101-2) is set so that the signal path is returned to a port on the wavelength multiplexing/demultiplexing unit 102-2 side (not illustrated), and a signal path in which the user device 300-2 and the access network management control unit 103-4 are connected via the coupling/splitting unit 400 and the optical cross-connect unit 101-2 is formed. Thus, it is possible to confirm the transmission from the user device 300-2 to the coupling/splitting unit 400 (equivalent to FIG. 13: here equivalent to FIG. 13 in that the user device on the right side corresponds to the user device 300-2 and is connected to the access network management control unit via the left turn, and the left and right are reversed). A signal path connecting the user device 300-2 to the access network management control unit 103-3 may be formed to confirm the transmission (equivalent to FIG. 12).

In this way, the communication system 1 exemplified in FIG. 1 includes the coupling/splitting unit 400. Thus, by switching the connection between the ports of the optical cross-connect unit 101-2, it is possible to divides the section and continue the transmission confirmation such as transmission confirmation of a signal path (via the signal path inside the optical cross-connect unit 101-2) in a section between the user device 300-1 and the coupling/splitting unit 400, and transmission confirmation of a signal path inside a section between the user device 300-2 and the coupling/splitting unit 400. Accordingly, the communication system 1 can determine signal path normality of all the signal paths between the user devices 300-1 and 300-2 also including the signal path of the section inside the optical cross-connect unit 101-2.

When the coupling/splitting unit 400 is configured using an optical switch, the coupling/splitting unit 400 does not split the signal path and executes switching.

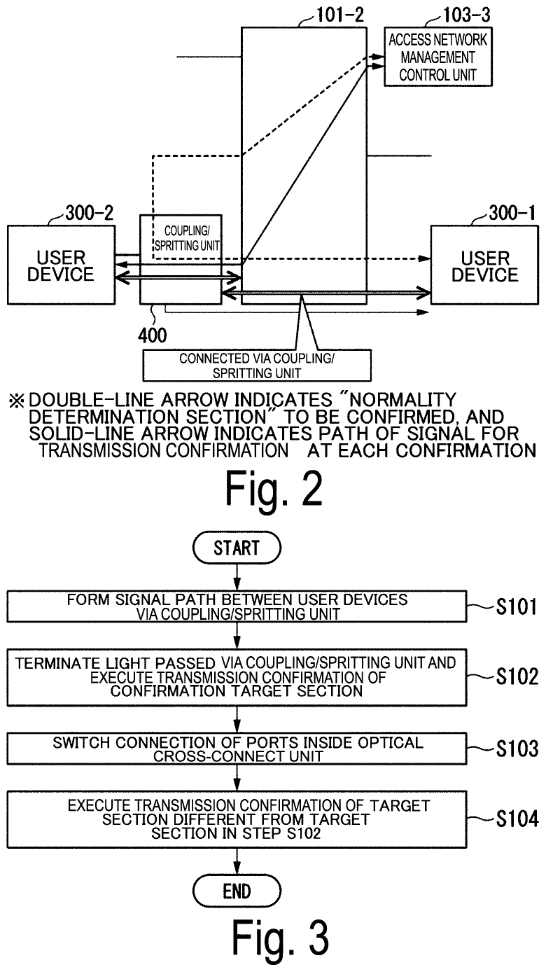

The above-described communication system 1 illustrated in FIG. 1 is different from the communication system exemplified below in FIG. 2, and the coupling/splitting unit 400 splits light transmitted from the user device 300-1 into a path toward the user device 300-2 and a path toward the access network management control unit 103-4 (rather than the access network management control unit 103-3 illustrated in FIG. 2 to be described below). The coupling/splitting unit 400 multiplexes the light transmitted from the user device 300-2 and the light transmitted from the access network management control unit 103-4 (rather than the access network management control unit 103-3 as illustrated in FIG. 2 to be described below) and transmits the multiplexed light to the path toward the user device 300-1. Accordingly, a signal path between the user devices 300-1 and 300-2 and a signal path between the user device 300-1 and the access network management control unit 103-4 (rather than the access network management control unit 103-3 as illustrated in FIG. 2 to be described below) are formed.

When the coupling/splitting unit 400 is used, the access network management control unit 103-4 and the user device 300-1, and the user devices 300-2 and 300-1 can be connected at the same time. For example, a main signal is exchanged between the user devices 300-1 and 300-2 and a main signal from the user device 300-1 is monitored by the access network management control unit 103-4, and a control signal is exchanged between the user device 300-1 and the access network management control unit 103-4. When the coupling/splitting unit 400 is replaced with a switch, it is necessary to select one of these connections. The user device 300-2 and the access network management control unit 103-3, and the user devices 300-2 and 300-1 cannot be connected at the same time.

In the case of the communication system 1 illustrated in FIG. 1, when the transmission of the signal path is confirmed in the section between the user device 300-1 and the coupling/splitting unit 400, the transmission in an access network management control unit 103-4 is confirmed using the user device 300-1, the optical cross-connect unit 101-1 (the signal path inside the optical cross-connect unit not indicated by a broken line in FIG. 1), the wavelength multiplexing/demultiplexing unit 102-1, the wavelength multiplexing/demultiplexing unit 102-2, the optical cross-connect unit 101-2 (a signal path inside the optical cross-connect unit not indicated by a broken line in FIG. 1), the coupling/splitting unit 400, and a signal path of the access network management control unit 103-4 (a signal path indicated by a broken line except the inside of the optical cross-connect unit 101-1 in FIG. 1).

In the case of the communication system 1 illustrated in FIG. 1, when transmission of the signal path is confirmed in the section between the user device 300-2 and the coupling/splitting unit 400, the transmission in the access network management control unit 103-3 is confirmed using the user device 300-2, the coupling/splitting unit 400, the optical cross-connect unit 101-2 (a signal path inside the optical cross-connect unit not indicated by a broken line in FIG. 1), and a signal path of the access network management control unit 103-3.

In the case of the communication system 1 illustrated in FIG. 1, in communication (between the user devices 300-2 and 300-1), a signal path for connecting the user device 300-2, the coupling/splitting unit 400, the optical cross-connect unit 101-2 (a signal path inside the optical cross-connect unit indicated by a broken line in FIG. 1), the wavelength multiplexing/demultiplexing unit 102-2, the wavelength multiplexing/demultiplexing unit 102-1, the optical cross-connect unit 101-1 (a signal path inside the optical cross-connect unit not indicated by a broken line in FIG. 1), and the user device 300-1 in order is formed.

In the case of the communication system 1 illustrated in FIG. 1, in the initial setting of the user device 300-2, the user device 300-2 is set from the access network management control unit 103-3 via the coupling/splitting unit 400 and the optical cross-connect unit 101-2 (a signal path inside the optical cross-connect unit not indicated by a broken line in FIG. 1). In the initial setting of the user device 300-1, the user device 300-1 is set from the coupling/splitting unit 400 (not illustrated in FIG. 1) and the access network management control unit 103-1 when the coupling/splitting unit 400 (not illustrated) of the Ph-GW 100-1 is included, or the user device 300-1 is set from the access network management control unit 103-2 via the coupling/splitting unit 400 (not illustrated in FIG. 1) and the optical cross-connect unit 101-1 (a signal path inside the optical cross-connect unit indicated by a broken line in the top left in FIG. 1) when the coupling/splitting unit 400 (not illustrated) of the Ph-GW 100-1 is included.

If one coupling/splitting unit 400 is provided for a pair of user devices 300-1 and 300-2, an unmonitored section can be eliminated including a signal path of a section inside the optical cross-connect unit 101. This is a minimum configuration.

The coupling/splitting unit 400 may be provided for each user device 300 (that is, one coupling/splitting unit 400 may be provided for each user device 300-1 and one coupling/splitting unit 400 may be provided for each user device 300-2).

In the above-described communication system 1 illustrated in FIG. 1, the access network management control unit 103 may be provided for each user device 300, or one input or output of the coupling/splitting unit 400 may be selected by an optical switch (not illustrated) and connected to the access network management control unit 103.

In FIG. 1, the configuration in which the coupling/splitting unit 400 is provided only in the Ph-GW 100-2 on the left side is exemplified. Therefore, when the optical cross-connect unit 101-1 divides and monitors the light, as illustrated in FIG. 1, an unmonitored section may be generated in a section of a signal path inside the optical switch included in the Ph-GW 100-1 on the right side. However, for example the coupling/splitting unit 400 is provided in the Ph-GW 100-1 similarly to the Ph-GW 100-2, and thus the signal path normality determination can be executed by switching the signal path as illustrated in FIG. 2, as will be described below, for the section of the signal path inside the optical switch included in the Ph-GW 100-1.

In FIG. 1, for example, the signal paths between the partner user devices can be divided between the left and right of the Ph-GW and between the gateways. The signal path normality determination may be executed for each of the divided sections. In order to divide the signal path between the left and right of the Ph-GW and between the gateways and eliminate an unmonitored section, it is necessary to dispose the coupling/splitting unit 400 at each point (for example, a total of four points of the left and right of Ph-GW 100-1 and the left and right of the Ph-GW 100-2 in the communication system 1 exemplified in FIG. 1) of the signal path of the main signal.

Conversely, when the signal path may be divided into two sections from the user device 300-2 on the left side to the left of the Ph-GW 100-2 on the left side and from the left of the Ph-GW 100-2 on the left side to the user device 300-1 on the right side and monitoring is executed, the coupling/splitting unit 400 may be disposed on the left side of the Ph-GW 100-2 on the left side. When the signal path may be divided into two sections from the user device 300-2 on the left side to the right of the Ph-GW 100-2 on the left side and from the right of the Ph-GW 100-2 on the left side to the user device 300-1 on the right side and monitoring is executed, the coupling/splitting unit 400 may be disposed on the right side of the Ph-GW 100-2 on the left side. When the signal path may be divided into two sections from the user device 300-2 on the left side to the left of the Ph-GW 100-1 on the right side and from the left of the Ph-GW 100-1 on the right side to the user device 300-1 on the right side and monitoring is executed, the coupling/splitting unit 400 may be disposed on the left side of the Ph-GW 100-1 on the right side. When the signal path may be divided into two sections from the user device 300-2 on the left side to the right of the Ph-GW 100-1 on the right side and from the right of the Ph-GW 100-1 on the right side to the user device 300-1 on the right side and monitoring is executed, the coupling/splitting unit 400 may be disposed on the right side of the Ph-GW 100-1 on the right side.

In FIG. 1, the configuration in the case in which the access network management control units 103-1 to 103-4 are used as termination portions for transmission confirmation is exemplified. However, the present invention is not limited to such a configuration, but each dedicated termination portion may be provided.

In FIG. 1, when the coupling/splitting unit 400 and the access network management control unit 103-4 have a one-to-one correspondence with the user device 300-1, the coupling/splitting unit 400 is provided for each port of the optical cross-connect unit 101-2 corresponding to the user device 300-1, but a path which is not connected to the user device 300-1 in the path in which the light is multiplexed or split by the coupling/splitting unit 400 is connected to the access network management control unit 103-4 via an optical switch (not illustrated) (the number of access network management control units 103-4 can be reduced more than the number of user devices through the connection).

Then, a set of coupling/splitting units 400 and access network management control units 103-4 are provided for each port of the optical cross-connect unit 101-2 corresponding to the user device 300-1, and thus an optical switch (not illustrated) selecting the coupling/splitting unit 400 and making connection to the access network management control unit 103-4 becomes unnecessary.

FIG. 2 is a diagram illustrating an example of a configuration for signal path normality determination according to the first embodiment of the present invention. In the communication system exemplified in FIG. 2, the coupling/splitting unit 400 provided outside of the optical switch splits light transmitted from the user device 300-1 into a path toward the user device 300-2 and a path toward the access network management control unit 103-3. The coupling/splitting unit 400 multiplexes the light transmitted from the user device 300-2 and the light transmitted from the access network management control unit 103-3, and transmits the multiplexed light to a path toward the user device 300-1. Thus, a signal path between the user device 300-1 and the user device 300-2 and a signal path between the user device 300-1 and the access network management control unit 103-3 are formed.

When the coupling/splitting unit 400 is configured using an optical switch, the coupling/splitting unit 400 does not split the signal path but executes switching.

The coupling/splitting unit 400 is connected to a plurality of ports of the user device 300-2 and an optical switch (optical cross-connect unit 101-2). The coupling/splitting unit 400 splits and outputs an output of one port (third port from the top left of the optical cross-connect unit 101-2 in FIG. 2) of the optical switch (optical cross-connect unit 101-2) to the other port (second port from the top left of the optical cross-connect unit 101-2 in FIG. 2) and the user device 300-2. The coupling/splitting unit 400 multiplexes outputs of the other port (the second port from the top left of the optical cross-connect unit 101-2 in FIG. 2) and the user device 300-2, and outputs the multiplexed output to one port (the third port from the top left of the optical cross-connect unit 101-2 in FIG. 2). The optical switch (optical cross-connect unit 101-2) can connect any of a plurality of ports of a plurality of optical switches (optical cross-connect units 101-2) connected to the coupling/splitting unit 400 to a port connected to the user device 300-1 and a control unit by internal connection.

The optical switch (optical cross-connect unit 101-2) can also connect a port of the optical switch (optical cross-connect unit 101-2) connected to the user device 300-1 to any of a plurality of ports of the optical switch (optical cross-connect unit 101-2) connected to the coupling/splitting unit 400 by internal connection.

On the other hand, in the communication system exemplified in FIG. 2, the optical switch (not illustrated) and the coupling/splitting unit exemplified above use the coupling/splitting unit without using the optical switch. In FIG. 2, a signal from the user device 300-1 output from the optical cross-connect unit and split by the coupling/splitting unit is input again to the optical cross-connect unit 101-2, a signal path is selected by the optical cross-connect unit 101-2 and connected to the access network management control unit 103-3, and a signal from the access network management control unit 103-3 is input to the coupling/splitting unit 400 by the optical cross-connect unit 101-2, input again to the optical cross-connect unit 101-2, and connected to the user device 300-1. Even in the case of the configuration illustrated in FIG. 2 to be described below, the coupling/splitting unit 400 can be replaced with an optical switch. In the configuration of the communication system exemplified in FIG. 2, two ports including a port connected to the user device 300 and a port connected to the access network management control unit 103-3 per user device 300 are required for the optical cross-connect unit 101-2. Therefore, the access network management control unit 103-3 can be shared, but the number of users accommodated in the optical cross-connect unit 101-2 is reduced.

In the communication system exemplified in FIG. 2, a port on the same side as a port on the user device 300-1 side of the optical cross-connect unit 101-2 is connected to the access network management control unit 103-3. The present invention is not limited to this configuration. As illustrated in FIG. 12, a port on the opposite side to the port on the user device 300-1 side may be connected to the access network management control unit 103-3.

When the access network management control unit 103 is provided for each user device 300, it is not necessary to provide an optical switch (not illustrated) for connecting each coupling/splitting unit 400 to the control unit, and the number of users accommodated in the optical cross-connect unit 101-2 is not reduced. Such a configuration is appropriate for a simple configuration in which the access network management control unit 103-3 executes OE conversion and detects a value of intensity.

FIG. 2, illustrates a configuration in which the optical cross-connect unit 101-2 also serves as an optical switch (not illustrated) selecting the coupling/splitting unit 400 and connecting to the access network management control unit 103-4 in FIG. 1. Therefore, an optical switch (not illustrated) is not required separately, but since a role of an optical switch (not illustrated) is also executed by the optical cross-connect unit 101-2, the number of users accommodated in the optical cross-connect unit 101-2 is reduced.

As a connection form during communication, the bottom left port and the top right port of the optical cross-connect unit 101-2 are connected, and the user device 300-2, the coupling/splitting unit 400, the optical cross-connect unit 101-2, and the user device 300-1 are connected to each other

When transmission is confirmed, the optical cross-connect unit 101-2 is switched to connect the bottom left and top right ports, and connect the user device 300-2, the coupling/splitting unit 400, the optical cross-connect unit 101-2, and the access network management control unit 103-3 in paths indicated by solid-line arrows of both sides, and transmission of both side arrow sections of a red double line from the user device 300-2 to the optical cross-connect unit 101-2 is confirmed. Then, the optical cross-connect unit 101-2 is switched to connect the bottom right and bottom left ports, and the user device 300-1, the optical cross-connect unit 101-2, the coupling/splitting unit 400, the optical cross-connect unit 101-2, and the access network management control unit 103-3 are connected in paths of broken line arrows on both sides, and transmission of both side arrow sections of a red double line from the coupling/splitting unit 400 to the user device 300-1 is confirmed. The order of the transmission confirmation may be reversed.

In the following description, a top side port (second port from the top left in the drawing) of the optical cross-connect unit 101-2 connected to the coupling/splitting unit 400 is connected only to the access network management control unit 103-3 (via a broken line on the top side inside the optical cross-connect unit 101-2). A bottom side port (third port from the top left in the drawing) of the optical cross-connect unit 101-2 connected to the coupling/splitting unit 400 is connected to one of the user device 300-1 and the access network management control unit 103-3 by selecting different internal connection of the optical cross-connect unit 101-1 (via either a solid line or a lower broken line inside the optical cross-connect unit 101-2).

When the user device 300-2 can be connected to the user device 300-1 and the access network management control unit 103-3 by any division multiplex (for example, time division multiplexing, wavelength division multiplexing, code division multiplexing, frequency division multiplexing, or the like) without changing the connection inside the optical cross-connect unit 101-2 or communication with the user device 300-1 and communication with the access network management control unit 103-3, the optical cross-connect unit 101-2 may be a WSS (Wavelength Selectable. Switch) or MCS (Multicast Switch).

In the initial setting of the user device 300-2, the optical cross-connect unit 101-2 connects the user device 300-2 and the access network management control unit 103-3 (via the coupling/splitting unit 400) (a signal path of a solid-line arrow in FIG. 2) and executes initial setting. In the initial setting of the user device 300-1, the optical cross-connect unit 101-2 connects the user device 300-1 and the access network management control unit 103-3 (by a signal path of a broken line arrow in FIG. 2) and executes the initial setting.

Here, the optical cross-connect unit 101-3 may be connected to the access network management control unit 103 (not illustrated) (by a signal path (not illustrated)) or may be connected to the access network management control unit 103-3 used for transmission confirmation in the embodiment via the coupling/splitting unit 400 (via a lower broken line inside the optical cross-connect unit 101-2 in FIG. 2, the coupling/splitting unit 400, and the upper broken line in the optical cross-connect unit 101-2).

In the latter case, the user device 300-1, a signal path (a signal path indicated by a lower broken line inside the optical cross-connect unit 101-2 in FIG. 2) (via a port of the optical cross-connect unit 101-2 on a signal path connecting the user device 300-1 to the user device 300-2), the coupling/splitting unit 400, a signal path inside the optical cross-connect unit 101-2 (a signal path indicated by an upper broken line inside the optical cross-connect unit 101-2 in FIG. 2) inside the optical cross-connect unit 101-2 (via a port of another optical cross-connect unit 101-2 which is not on a signal path connecting the user device 300-1 to the user device 300-2), and the access network management control unit 103-3 are connected (in the whole signal path indicated by the broken line in FIG. 2).

In communication between the user device 300-2 and the user device 300-1, the optical cross-connect unit 101-2 connects the user device 300-2 to the user device 300-1 (via the coupling/splitting unit 400). That is, the user device 300-1, a signal path (a signal path along a lower broken line among broken lines inside the optical cross-connect unit 101-2 in FIG. 2) inside the optical cross-connect unit 101-2 (via a port of the optical cross-connect unit 101-2 on a signal path connecting the user device 300-1 to the user device 300-2), the coupling/splitting unit 400, and the user device 300-2 are connected.

When transmission from the user device 300-2 to the coupling/splitting unit 400 is confirmed, an optical switch (optical cross-connect unit 101-2) connects the user device 300-2 to the access network management control unit 103-3 (via the coupling/splitting unit 400) (in a signal path indicated by a solid line in FIG. 2).

When confirming transmission from the user device 300-1 to the coupling/splitting unit 400 via a signal path inside the optical switch (optical cross-connect unit 101-2) in communication between the user devices 300-2 and 300-1, an optical switch (optical cross-connect unit 101-2) connects the user device 300-1 to the coupling/splitting unit 400 (in a signal path indicated by a lower broken line in FIG. 2) and connects the coupling/splitting unit 400 to the access network management control unit 103-3 (via a port different from a port by which the coupling/splitting unit 400 is connected to the user device 300-1) (in a signal path indicated by an upper broken line in FIG. 2).

In this way, the communication system exemplified in FIG. 2 includes the coupling/splitting unit 400. Thus, by switching the connection between the ports of the optical cross-connect unit 101-2, it is possible to divide the section and continue the transmission confirmation such as transmission confirmation of a signal path (via the signal path inside the optical cross-connect unit 101-2) in a section between the user device 300-1 and the coupling/splitting unit 400, and transmission confirmation of a signal path inside a section between the user device 300-2 and the coupling/splitting unit 400. Accordingly, the communication system can determine signal path normality of all the signal paths between the user devices 300-1 and 300-2 also including the signal path of the section inside the optical cross-connect unit 101-2. In FIG. 2, the coupling/splitting unit 400 installed for each user device is selected between the user device and the optical cross-connect unit in FIG. 1, and an optical switch (not illustrated) making connection to the access network management control unit 103-4 is eliminated, the optical cross-connect unit 101-2 is used instead of the optical switch (not illustrated) and a path splitting to a device other than the user device side of the coupling/splitting unit 400 installed for each user device is connected to the access network management control unit 103-3. Therefore, an optical switch (not illustrated) separately provided in FIG. 1 is not required. Here, since a role of the optical switch (not illustrated) is also executed by the optical cross-connect unit 101-2, the number of users that can be accommodated by the optical cross-connect unit 101-2 is reduced.

The communication system exemplified in FIG. 2 has a configuration in which the single access network management control unit 103-3 executes signal path normality determination of a section between the user device 300-1 and the optical cross-connect unit 101-2, a section between the user device 300-2 and the optical cross-connect unit 101-2, and a section inside the optical cross-connect unit 101-2. FIG. 2 exemplifies a configuration in which the coupling/splitting unit 400 is provided between the optical cross-connect unit 101-2 and the user device 300-2 on the left side. Here, the present invention is not limited to such a configuration, but may have a configuration in which the coupling/splitting unit 400 is provided between the optical cross-connect unit 101-2 and the user device 300-1 on the right side.

FIG. 2 exemplifies a configuration in which the signal path from the coupling/splitting unit 400 to a termination portion (access network management control unit 103-3) is passed via the optical cross-connect unit 101-2. Here, the present invention is not limited to such a configuration, but a signal path from the coupling/splitting unit 400 to the termination portion (access network management control unit 103-3) may not be passed via the optical cross-connect unit 101-2.

### [Operation of Communication System]

Hereinafter, an example of an operation when signal path normality determination of the communication system 1 is executed will be described. As an example, operation will be described based on the configuration of the communication system 1 illustrated in FIG. 1 described above. FIG. 3 is a flowchart illustrating an operation of the communication system 1 according to the first embodiment of the present invention.

The coupling/splitting unit 400 splits light transmitted from the user device 300-1 into a path toward the user device 300-2 and a path toward the access network management control unit 103-4. The coupling/splitting unit 400 multiplexes the light transmitted from the user device 300-2 and the light transmitted from the access network management control unit 103-4, and transmits the multiplexed light to a path toward the user device 300-1. Accordingly, a signal path between the user devices 300-1 and 300-2 and a signal path between the user device 300-1 and the access network management control unit 103-4 are formed (step S101).

When an optical switch is used in place of the coupling/splitting unit 400, the optical switch switches the light transmitted from the user device 300-1 to either a path toward the user device 300-2 or a path toward the access network management control unit 103-4. The optical switch switches between the light transmitted from the user device 300-2 and the light transmitted from the access network management control unit 103-4, and transmits either the light to a path toward the user device 300-1. A signal path between the user device 300-1 and the user device 300-2 is formed in communication by the main signal, and a signal path between the user device 300-1 and the access network management control unit 103-4 is formed in confirmation of transmission (step S101).

For example, in the case of the communication system 1 illustrated in FIG. 1, a signal path for connecting the user device 300-1, the optical cross-connect unit 101-1 (a signal path inside the optical cross-connect unit not indicated by a broken line in FIG. 1), the wavelength multiplexing/demultiplexing unit 102-1, the wavelength multiplexing/demultiplexing unit 102-2, the optical cross-connect unit 101-2, the coupling/splitting unit 400, and a signal path of the access network management control unit 103-4 (a signal path indicated by a broken line except for the inside of the optical cross-connect unit 101-1 in FIG. 1) in order is formed.

The present invention is not limited to the direct connection between the coupling/splitting unit 400 and the access network management control unit 103. For example, in the case of the communication system 1 illustrated in FIG. 1, the access network management control unit 103 may be shared by a plurality of coupling/splitting units 400 via an optical switch (not illustrated).

Subsequently, the access network management control unit 103-4 terminates light transmitted from the user device 300-1 and passed via the optical cross-connect unit 101-1, the optical cross-connect unit 101-2, the coupling/splitting unit 400, and the like and communicates with the user device 300-1 to execute transmission confirmation (step S102).

More specifically, for example, in the case of the communication system 1 illustrated in FIG. 1, the transmission of the signal path in which a section between the user device 300-1 and the coupling/splitting unit 400 is set as a target section is confirmed. The transmission in the access network management control unit 103-4 is confirmed using a signal path of the user device 300-1, the optical cross-connect unit 101-1 (a signal path inside the optical cross-connect unit not indicated by a broken line in FIG. 1), the wavelength multiplexing/demultiplexing unit 102-1, the wavelength multiplexing/demultiplexing unit 102-2, the optical cross-connect unit 101-2, the coupling/splitting unit 400, and the access network management control unit 103-4 (a signal path indicated by a broken line except the inside of the optical cross-connect unit 101-1 in FIG. 1).

Subsequently, port connection inside the optical cross-connect unit 101-1 is switched (step S103). Accordingly, a signal path (different from the signal path formed in step S101) for executing transmission confirmation by setting a section other than the section defined as the target section in step S102 as a target section is formed.

More specifically, for example, in the case of the communication system 1 illustrated in FIG. 1, a signal path for connecting the user device 300-2, the coupling/splitting unit 400, the optical cross-connect unit 101-2 (a signal path inside the optical cross-connect unit not indicated by a broken line in FIG. 1), and the access network management control unit 103-3 in order is formed.

When an optical switch is used in place of the coupling/splitting unit 400, the optical switch switches the light transmitted from the user device 300-1 to either a path toward the user device 300-2 or a path toward the access network management control unit 103-4. The optical switch switches between light transmitted from the user device 300-2 and light transmitted from the access network management control unit 103-4, and transmits either the light to a path toward the user device 300-1. In step S103, a signal path is formed between the access network management control unit 103-3 and the user device 300-2 similarly to the communication by the main signal (step S101).

Subsequently, the access network management control unit 103-3 terminates the light transmitted from the user device 300-2 and passed via the coupling/splitting unit 400 and the optical cross-connect unit 101-2 and communicates with the user device 300-2 to execute transmission confirmation (step S102).

More specifically, for example, in the case of the communication system 1 illustrated in FIG. 1, the transmission of the signal path in which a section between the user device 300-2 and the coupling/splitting unit 400 is set as a target section is confirmed. The transmission in the access network management control unit 103-3 is confirmed using a signal path of the user device 300-2, the coupling/splitting unit 400, the optical cross-connect unit 101-2 (a signal path inside the optical cross-connect unit not indicated by a broken line in FIG. 1), and the access network management control unit 103-3. The operation of the communication system 1 illustrated in the flowchart of FIG. 3 ends as described above.

The above-described operation has been described by giving the operation of the communication system 1 illustrated in FIG. 1 as an example. However, the present invention is not limited to this configuration and the following configuration may be used For example, the coupling/splitting unit 400 may split a signal path from the optical cross-connect unit 101-2 into a signal path to the user device 300-2 and a signal path to the access network management control unit 103-3 (via the optical cross-connect unit 101-2) without splitting the signal path into a signal path to the user device 300-2 and a signal path to the access network management control unit 103-4.

In this case, not only the user device 300-2 executes normality determination with the access network management control unit 103-3, but also the user device 300-1 executes normality determination with the access network management control unit 103-3 (via the optical cross-connect unit 101-2) after split by the coupling/splitting unit 400 (via the optical cross-connect unit 101-2). As described above, in the communication system 1 illustrated in FIG. 1, the user device 300-1 executes normality determination with the access network management control unit 103-4 directly after split by the coupling/splitting unit 400 (via the optical cross-connect unit 101-2).

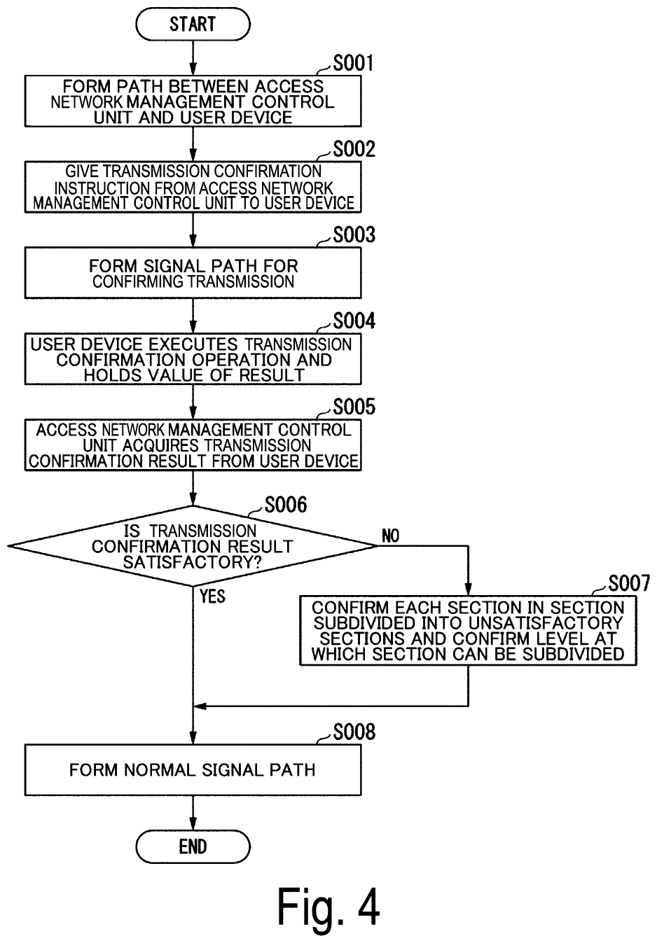

As a method of executing signal path normality determination, a configuration of a case in which the light transmitted from the user device 300-1 and split by the coupling/splitting unit 400 is terminated by the access network management control unit 103-4 in FIG. 1 and terminated by the access network management control unit 103-4 in FIG. 2, and the access network management control unit 103-3 terminates the light transmitted from the user device 300-2 to confirm transmission will be exemplified. However, the present invention is not limited to such a configuration. For example, a method of executing signal path normality determination by a set of a response confirmation request and a confirmation response to the response confirmation request may be used. As an example, description will be made based on the configuration of the communication system 1 illustrated in FIG. 1 described above. In this case, the communication system 1 operates as illustrated in FIG. 4. FIG. 4 is a flowchart illustrating another example of the operation of the communication system 1 according to the first embodiment of the present invention.

For example, in the case of connection to the access network management control unit 103-4, the coupling/splitting unit 400 splits the light transmitted from the user device 300-1 into a path toward the user device 300-2 and a path toward the access network management control unit 103-4. For example, in the case of connection to the access network management control unit 103-3, the coupling/splitting unit 400 may split the light transmitted from the user device 300-1 into a path toward the user device 300-2, and a path toward the access network management control unit 103-3 (via the optical cross-connect unit 101-2 or not via the optical cross-connect unit 101-2).

The coupling/splitting unit 400 multiplexes the light transmitted from the user device 300-2 and the light transmitted from the access network management control unit 103-4, and transmits the multiplexed light to a path toward the user device 300-1. Accordingly, a signal path between the user devices 300-1 and 300-2 and a signal path between the user device 300-1 and the access network management control unit 103-4 are formed (step S001). This signal path is a signal path formed even in normal communication. When the coupling/splitting unit 400 is configured using an optical switch, the optical switch switches a signal path between the user devices 300-1 and 300-2, and thus forms a signal path between the user device 300-1 and the access network management control unit 103-4.

The access network management control unit 103-4 transmits an instruction to execute transmission confirmation to the user device 300-1. The access network management control unit 103-3 transmits an instruction to execute transmission confirmation to the user device 300-2 (step S002). Each of the user devices 300-1 and 300-2 receives an instruction to execute transmission confirmation (step S002).

The optical cross-connect unit 101-2 switches the signal path connecting the user device 300-2 to the user device 300-1 via the coupling/splitting unit 400 to the signal path connecting the user device 300-2 to the access network management control unit 103-3 via the optical switch. Accordingly, a path for executing transmission confirmation of a signal path (also including a signal path inside the optical cross-connect unit 101-2) between the user device 300-2 and the access network management control unit 103-3 is formed. Further, a path for executing transmission confirmation of a signal path between the user device 300-1 and the access network management control unit 103-4 is formed (step S003).

When the instruction to execute the transmission confirmation is received, the user device 300-1 responds to the instruction, loops back a loopback signal of loopback processing, transmits the loopback signal of the loopback processing, and terminates the looped-back loop signal, and thus executes transmission confirmation of a path between the own user device 300-1 and the access network management control unit 103-4 in order to confirm transmission of a signal path (also including a signal path inside the optical cross-connect unit 101-2) between the user device 300-1 and the coupling/splitting unit 400, and holds a value of a result. When the instruction to execute the transmission confirmation is received, the user device 300-2 responds to the instruction, loops back a loopback signal from the control unit of loopback processing to the control unit, transmits the looped-back signal of the loopback processing to the control unit, and terminates the loop signal looped back from the control unit, and thus confirms transmission of the path between the own user device 300-2 and the access network management control unit 103-3 in order to confirm the transmission of the signal path between the user device 300-2 and the coupling/splitting unit 400, and holds the value of the result (step S004).

Subsequently, the user device 300-1 transmits the result of the transmission confirmation to the access network management control unit 103-4.

In the case of a configuration for responding to the instruction to execute transmission confirmation, the result of the transmission confirmation is transmitted in the response. In the case of a configuration for looping back a loopback signal of loopback processing, the result of the transmission confirmation is acquired by the access network management control unit 103-4 and is not acquired by the user device 300-1. In the case of a configuration for transmitting a loopback signal of loopback processing and terminating the looped-back loop signal, the user device 300-1 transmits the result of the transmission confirmation as described above.

Before the user device 300-1 communicates with the access network management control unit 103-4, it is necessary to switch the signal path so that the user device 300-1 can communicate with the access network management control unit 103-4.

The user device 300-2 transmits the result of the transmission confirmation to the access network management control unit 103-3.

In the case of a configuration for responding to an instruction to execute transmission confirmation, the result of the transmission confirmation is transmitted in the response. In the case of a configuration for looping back a loopback signal of loopback processing, the result of the transmission confirmation is acquired by an access network management control unit 103-3 and is not acquired by the user device 300-2. In the case of a configuration for transmitting a loopback signal of loopback processing and terminating the looped-back loop signal, the user device 300-2 transmits the result of the transmission confirmation as described above.

Before the user device 300-2 communicates with the access network management control unit 103-3, it is necessary to switch the signal path so that the user device 300-2 can communicate with the access network management control unit 103-3.

The access network management control unit 103-4 acquires the result of the transmission confirmation transmitted from the user device 300-1. The access network management control unit 103-3 acquires the result of the transmission confirmation transmitted from the user device 300-2 (step S005).

When the result of the transmission confirmation acquired by the access network management control unit 103-3 or the result of the transmission confirmation acquired by the access network management control unit 103-4 is unsatisfactory (that is, when error is recognized in the signal path of a transmission confirmation target) (NO in step S006), each of the subdivided sections of the unsatisfactory section is confirmed and confirmed up to a subdividable level.

When the error is recognized in the signal path of the transmission confirmation target, a signal path for bypassing the signal path in which the error is recognized may be formed instead of subdividing the unsatisfactory section as described above and (when it is difficult to realize such a configuration), a configuration for announcing an alarm may be realized.

Conversely, when the result of the transmission confirmation acquired by the access network management control unit 103-3 and the result of the transmission confirmation acquired by the access network management control unit 103-4 are satisfactory (that is, when no error is recognized in the signal path of the transmission confirmation target) (YES in step S006), the optical cross-connect unit 101-2 executes switching so that a signal path connecting the user device 300-2 to the access network management control unit 103-3 via the coupling/splitting unit 400 is a signal path connecting the user device 300-2 to the user device 300-1 via the coupling/splitting unit 400. Accordingly, a normal signal path between the user device 300-2 and access network management control unit 103-3 is formed. A normal signal path between the user device 300-1 and the access network management control unit 103-4 is formed (step S008). When an optical switch is used in place of the coupling/splitting unit 400, return of the optical switch is also switched. As described above, the operation of the communication system 1 illustrated in the flowchart of FIG. 4 ends.

For example, when the result of the transmission confirmation of the user device 300-1 from the coupling/splitting unit 400 by the access network management control unit 103-4 is satisfactory and the result of the transmission confirmation of the user device 300-2 from the coupling/splitting unit by the access network management control unit 103-3 is also satisfactory, the Ph-GW 100-2 determines that the signal paths of all the sections between the user device 300-1 and the user device 300-2 are satisfactory.

For example, when the result of the transmission confirmation of the user device 300-1 from the coupling/splitting unit 400 by the access network management control unit 103-4 is satisfactory and the result of the transmission confirmation of the user device 300-2 from the coupling/splitting unit 400 by the access network management control unit 103-3 is unsatisfactory (abnormal), the Ph-GW 100-2 determines that the signal path of the section between the optical cross-connect unit 101-2 and the user device 300-1 and the section inside the optical cross-connect unit 101-2 is satisfactory and the signal path of the section between the user device 300-2 and the optical cross-connect unit 100-2 is abnormal.

For example, when the result of the transmission confirmation of the user device 300-1 from the coupling/splitting unit 400 by the access network management control unit 103-4 is abnormal and the result of the transmission confirmation of the user device 300-2 from the coupling/splitting unit 400 by the access network management control unit 103-3 is normal, the Ph-GW 100-2 determines that there is error in any signal path of the section between the coupling/splitting unit 400 and the optical cross-connect unit 101-2, the section between the optical cross-connect unit 101-2 and the optical cross-connect unit 101-1, the section inside the optical cross-connect unit 101-1, and the section between the optical cross-connect unit 101-1 and the user device 300-1, and determines that the signal path of the section between the optical cross-connect unit 100-2 and the user device 300-2 is normal.

Additionally, the section between the coupling/splitting unit 400 and the user device 300-1 is divided, normality of the divided sections is confirmed, and an abnormal section is identified. The normality of a section between the coupling/splitting unit 400 and the optical cross-connect unit 101-2 is determined by forming a signal path connecting the access network management control unit 103-4, the coupling/splitting unit 400, the optical cross-connect unit 101-2, and the access network management control unit 103-3 in order. The normality of a section between the optical cross-connect units 101-2 and 101-1 is determined by making connection of the access network management control unit 103-4, the optical cross-connect unit 101-2, the multiplexing/demultiplexing unit 102-2, the wavelength multiplex/demultiplexing unit 102-1, the optical cross-connect unit 101-1, and the access network management control unit 103-1 and forming a signal path connecting the access network management control unit 103-4, the coupling/splitting unit 400, the optical cross-connect unit 101-2, and the access network management control unit 103-3 in order. The signal path between the optical cross-connect unit 101-2 and the optical cross-connect unit 101-1 is estimated to be abnormal when the access network management control unit 103-4 and the access network management control unit 103-3 are normal and the access network management control unit 103-4 and the access network management control unit 103-1 are abnormal. The normality of the section between the optical cross-connect unit 101-1 and the user device 300-1 is determined by forming a signal path connecting the access network management control unit 103-2, the optical cross-connect unit 101-1 and the user device 300-1 in order.

In the configuration illustrated in FIG. 1, since the Ph-GW 100-1 does not include the coupling/splitting unit 400, the normality of the signal path inside the optical cross-connect unit 101-1 cannot be confirmed. Here, when the Ph-GW 100-1 includes the coupling/splitting unit 400, the normality of the signal path inside the optical cross-connect unit 101-1 can be confirmed.

When the coupling/splitting unit 400 (not illustrated) is included, the section of which the normality is confirmed can be extended or further divided.

For example, when the result of the transmission confirmation of the user device 300-1 from the coupling/splitting unit 400 by the access network management control unit 103-4 is abnormal and the result of the transmission confirmation of the user device 300-2 from the coupling/splitting unit 400 by the access network management control unit 103-3 is also abnormal, the Ph-GW 100-2 determines that there is error in any signal path of the section between the coupling/splitting unit 400 and the optical cross-connect unit 101-2, the section between the optical cross-connect unit 101-2 and the optical cross-connect unit 101-1, the section inside the optical cross-connect unit 101-1 and the section between the optical cross-connect unit 101-1 and the user device 300-1, and determines that there is also error in the signal path of the section between the optical cross-connect unit 100-2 and the user device 300-2.

It can be determined which section is abnormal between the section between the optical cross-connect unit 101-2 and the user device 300-1 and the section inside the optical cross-connect unit 101-2 by further confirming transmission between the access network management control unit 103-1 and the user device 300-2 and confirming transmission between the access network management control unit 103-4 and the user device 300-1 without passing via the optical cross-connect unit 101-2 and the coupling/splitting unit 400 through switching by the optical cross-connect unit 101-2.

The coupling/splitting unit 400 in FIGS. 1 and 2 may be replaced by an optical switch. Further, the optical switches are (N+1)×N (where N is the number of user devices 300 connected to one port) optical switches, N ports among the ports of the (N+1) side may be connected to the user device 300, the remaining one port may be connected to the access network management control unit 103, and N ports of the N side ports may be connected to N ports of the optical cross-connect unit 101. In this case, the foregoing optical switch (not illustrated) sharing the access network management control unit 103 among the plurality of user devices 300 has an effect that the installation of the coupling/splitting unit 400 can be omitted.

Since the communication system 1 exemplified in FIG. 1 includes the coupling/splitting unit 400 on the left side of the (left) Ph-GW 100-2, an unmonitored section can be eliminated by confirming transmission of a left side section from the (left) user device 300-2 to the left end of the (left) Ph-GW 100-2, and transmission of a right section from the left end of the (left) Ph-GW 100-2 to the (right) user device 300-1 in the signal path of the main signal.

When a plurality of optical switches are provided in the signal path, an unmonitored section can be eliminated and the section can be identified in combination with the following confirmation processing. When a plurality of optical switches are provided in the signal path, monitoring may be executed similarly to the foregoing modification in which the coupling/splitting unit 400 according to the present application is replaced by one optical switch.

In order to further divide the section and confirm the transmission, for example, in the case of the communication system 1 exemplified in FIG. 1, between the Ph-GW 100-1 and the Ph-GW 100-2, transmission can be confirmed in the case of a path indicated by a heavy broken-line arrow between the access network management control unit 103-4, the coupling/splitting unit 400, the optical cross-connect unit 101-2, the wavelength multiplexing/demultiplexing unit 102-2, the wavelength multiplexing/demultiplexing unit 102-1, the optical cross-connect unit 101-1, and the access network management control unit 103-1 (in the case of a path indicated by a solid line, the access network management control unit 103-4, the optical cross-connect unit 101-2, the wavelength multiplexing/demultiplexing unit 102-2, the wavelength multiplexing/demultiplexing unit 102-1, the optical cross-connect unit 101-1, and the access network management control unit 103-1), the transmission of the access section on the right side (that is, between the optical cross-connect unit 101-1 and the user device 300-1) is confirmed in the access network management control unit 103-2, the optical cross-connect unit 101-1, and the user device 300-1, and a section in which error occurs can be identified in combination with the transmission confirmation according to the present application.

As described above, the communication system 1 according to the first embodiment of the present invention includes the coupling/splitting unit 400 outside of the optical switch. The communication system 1 terminates the light split by the coupling/splitting unit 400 provided outside of the optical switch by an optical transceiver (optical TRx) of a user device instead of terminating the light of which the signal path is switched in the optical switch, and executes section monitoring. With such a configuration, the communication system 1 according to the first embodiment can determine the normality of the signal path even in the section of the signal path inside the optical switch.

### Second Embodiment

In the above-described first embodiment, the main signal path is divided and terminated without an unmonitored section using the coupling/splitting unit 400, but the following configuration can be adopted.

In a communication system according to a second embodiment, instead of terminating the light of which the signal path is switched inside the optical switch, a section is monitored by disconnecting one user device from the communication system, changing the signal path to loop back light transmitted toward the disconnected user device to a user device of a transmission source, and terminating the signal path by an optical transceiver of the user device of the transmission source.

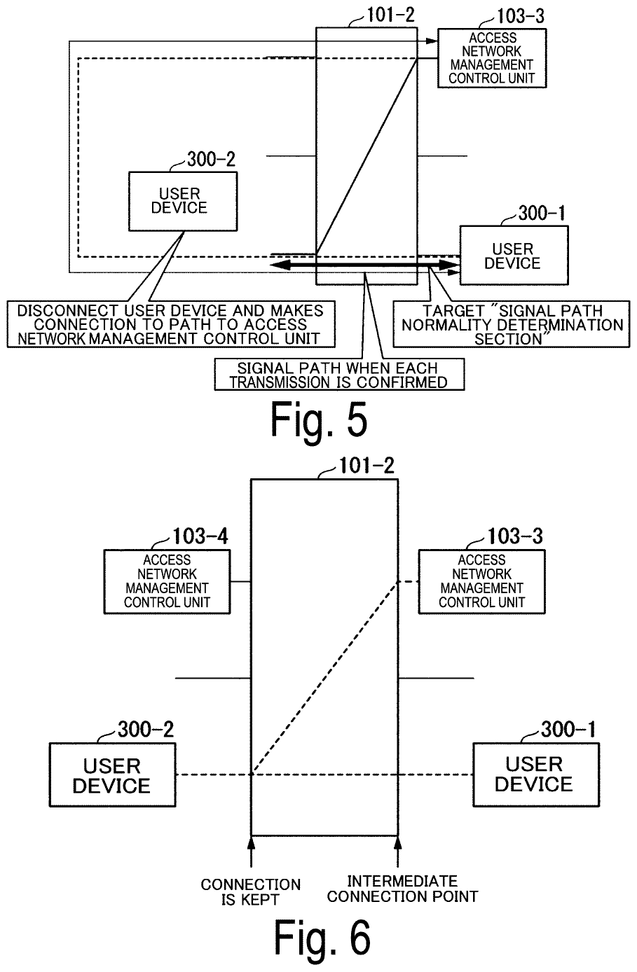

That is, as illustrated in FIG. 5, for example, when signal path normality determination is executed, the communication system according to the second embodiment disconnects the user device 300-2 and changes a signal path so that light transmitted from the user device 300-1 to the user device 300-2 is transmitted to the access network management control unit 103-3. In the communication system exemplified in FIG. 5, the signal path is connected again to the access network management control unit 103-3 via the optical cross-connect unit 101-2, but the present invention is not limited to such a configuration. The signal path may be connected to the access network management control unit 103-3 without being passed via the optical cross-connect unit 101-2. With such a configuration, the communication system according to the second embodiment can execute signal path normality determination even on a section of a signal path inside the optical switch.

As described above, the communication system according to the second embodiment of the present invention disconnects one user device from the communication system in place of terminating the light of which the signal path is switched in the optical switch to the access network management control unit when the signal path normality determination is executed. Then, the signal path is changed so that the light transmitted from the user device 300-1 and transmitted via the signal path also including the section inside the optical cross-connect unit 101-2 is transmitted to the access network management control unit. The access network management control unit terminates the transmitted light and monitors the section by executing transmission confirmation with the user device of the transmission source. With such a configuration, the communication system according to the second embodiment can execute the signal path normality determination even on the section of the signal path inside the optical switch.

### Third Embodiment

The signal path normality determination is executed in the configuration of the optical switch of the related art by loop-back the signal path using the coupling/splitting unit 400 in the above-described first embodiment and by disconnecting one user device from the communication system and loop-back the signal path when the signal path normality determination is executed in the above-described second embodiment. On the other hand, a communication system according to a third embodiment to be described below uses a special optical switch.

As illustrated in FIG. 6, in the third embodiment, the signal path connecting a port of the user device 300-2 on the left side to a port of the user device 300-1 on the right side is modified without being switched. For example, in FIG. 6, although an optical fiber extends rightward from a port connected to the user device 300-2 on the left side, the optical fiber is normally connected to the port connected to the user device 300-1 on the right side in the normal time. On the other hand, when the signal path normality determination is executed, the optical fiber is connected to a port connected to the access network management control unit 103-3 instead of being connected to a port connected to the side user device 300-1 on the right side.

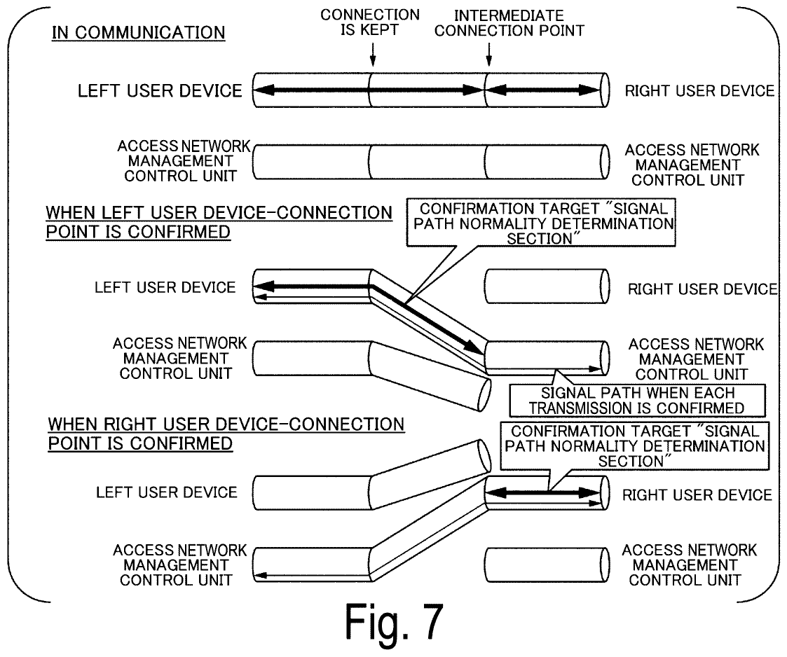

The modification of the signal path by the special optical switch according to the third embodiment will be described in more detail with reference to FIG. 7. A state of a signal path at the normal time is illustrated in the upper stage of FIG. 7. As illustrated in the drawing, a signal path connecting the user device on the left side and the user device on the right side and a signal path connecting the access network management control unit on the left side and the access network management control unit on the right side are formed at the normal time.

When the main signal is transmitted, the access network management control units 103 may not be connected by a signal path.

In the middle stage of FIG. 7, when the signal path normality determination is executed on a signal path of a section between the user device on the left side and a left port of the optical switch (optical cross-connect unit) and a signal path of a section between a left connection port of the optical switch and an intermediate connection point inside the optical switch, states of the signal paths are illustrated. As illustrated in the drawing, when signal path normality determination of the signal path of the section between the user device on the left side and an intermediate connection point inside the optical switch is executed, the signal path is modified so that an optical fiber extending from a port connected to the user device on the left side is connected to a port connected to the access network management control unit on the right side at the intermediate connection point.

On the other hand, in the lower stage of FIG. 7, when signal path normality determination is executed on a signal path of a section between the user device on the right side and the right port of the optical switch and a signal path of a section between the right connection port of the optical switch and the intermediate connection point inside the optical switch, the states of the signal paths are illustrated. As illustrated in the drawing, when the signal path normality determination on the signal path of the section between the user device on the right side and the intermediate connection point inside the optical switch is executed, a signal path is modified so that the signal path such as an optical fiber extending from the port connected to the user device on the right side is connected to the port connected to the access network management control unit on the left side at the intermediate connection point.

In this way, the communication system according to the third embodiment of the present invention uses a special switch which can modify the signal path inside the optical switch and change a connection destination at the intermediate connection point inside the optical switch. Accordingly, in the communication system according to the third embodiment, instead of switching the signal path by the optical switch, the user device can be connected to the access network management control unit by modifying the signal path inside the optical switch.

In a normal optical switch, for example, a separate wiring is used between a port connected to the user device on the left side and a port connected to the user device on the right side and between a port connected to the user device on the left side and a port connected to the access network management control unit. On the other hand, in the communication system according to the third embodiment, the signal path inside the optical switch can be modified using a special switch. Accordingly, in the communication system according to the third embodiment, since connection to different partner ports can be made as the signal path is modified, an unmonitored section can be eliminated without changing the connection of the signal path.

### Fourth Embodiment

A communication system according to a fourth embodiment to be described below uses a special optical switch as in the above-described third embodiment and has a configuration different from the configuration of the optical switch according to the third embodiment. The optical switch used in the communication system according to the third embodiment is the special switch which can modify the signal path inside the optical switch and change the connection destination at the intermediate connection point inside the optical switch, as described above. On the other hand, the optical switch used in the communication system according to the fourth embodiment is configured to reflect the transmitted light at a reflection point inside the optical switch and modify the signal path by changing a reflection direction to a desired direction.

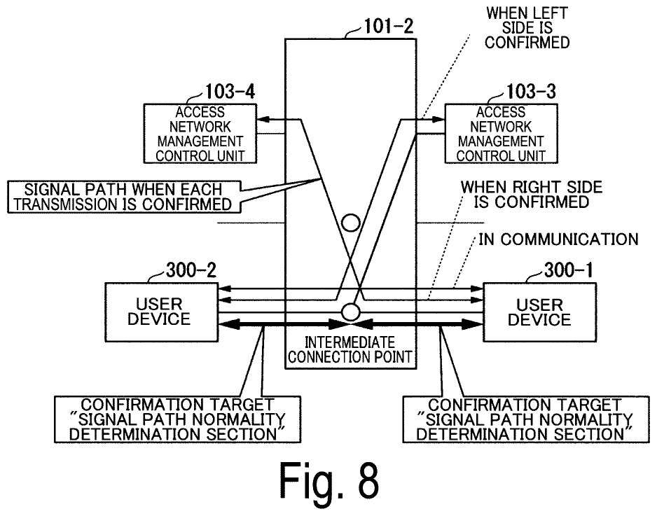

As illustrated in FIG. 8, in the communication system according to the fourth embodiment, the port connected to the user device 300-2 on the left side and the port connected to the user device 300-1 on the right side are connected at an intermediate connection point inside the optical switch. For example, in FIG. 8, the optical fiber extends from the port connected to the user device 300-2 on the left side to the right. However, at the normal time, the optical fiber is connected to a port connected to the user device 300-1 on the right side at the intermediate connection point. On the other hand, when the signal path normality determination is executed, the port is connected to a port connected to the access network management control unit 103-3 on the right side instead of being connected to a port connected to the user device 300-1 on the right side.

That is, at the normal time, the intermediate connection point connecting a path toward the user device 300-1 and a path toward the user device 300-2 is switched to connect a path toward the user device 300-1 and a path toward the access network management control unit 103-4. Accordingly, the normality of the section between the user device 300-1 and the intermediate connection point can be confirmed by the access network management control unit 103-4. Further, the intermediate connection point is switched to connect a path toward the user device 300-2 and a path toward the access network management control unit 103-3. Accordingly, the normality of the section between the user device 300-2 and the intermediate connection point can be confirmed by the access network management control unit 103-3. Accordingly, the normality of the signal path between the user device 300-1 and the user device 300-2 also including the signal path inside the optical cross-connect unit 101-2 can be confirmed.

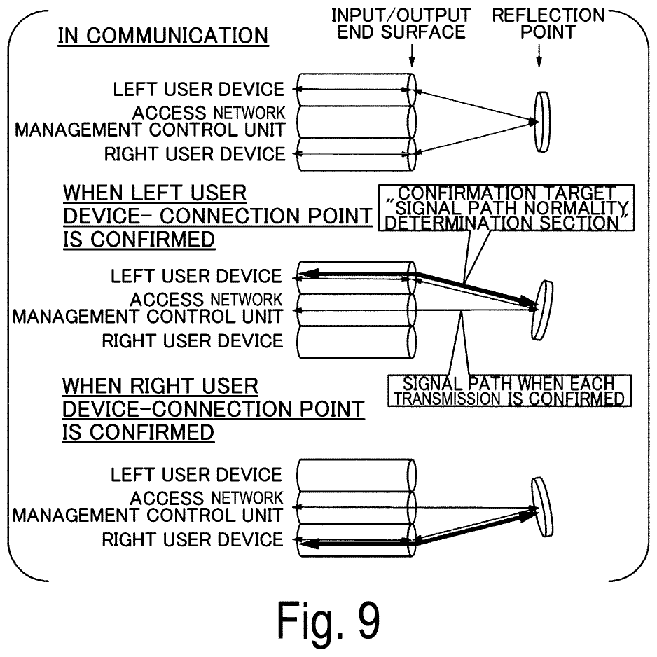

The switching of the signal path by the special optical switch according to the fourth embodiment will be described in more detail with reference to FIG. 9. The state of the signal path at the normal time is illustrated in the upper stage of FIG. 9. As illustrated in the drawing, a reflection direction of the light at the reflection point that is an intermediate connection point at which the light is reflected is set so that a signal path connecting the user device on the left side and the user device on the right side and a signal path connecting the access network management control unit on the left side and the access network management control unit on the right side are formed at normal times.

In the middle stage of FIG. 9, when the signal path normality determination is executed on a signal path of a section between the user device on the left side and a left port of the optical switch (optical cross-connect unit) and a signal path of a section between a left connection port of the optical switch and a reflection point inside the optical switch, states of the signal paths are illustrated. As illustrated in the drawing, when signal path normality determination of a signal path of a section between the user device on the left side and the reflection point inside the optical switch is executed, a reflection direction of the light at the reflection point is set so that the signal path extending from a port connected to the user device on the left side is connected to a port connected to the access network management control unit at the reflection point.

On the other hand, in the lower stage of FIG. 9, when signal path normality determination is executed on a signal path of a section between the user device on the right side and the right port of the optical switch and a signal path of a section between the right connection port of the optical switch and the reflection point inside the optical switch, the states of the signal paths are illustrated. As illustrated in the drawing, when the signal path normality determination on the signal path of the section between the user device on the right side and the intermediate connection point inside the optical switch is executed, a reflection direction of the light at the reflection point is set so that the signal path extending from the port connected to the user device on the right side is connected to the port connected to the access network management control unit at the reflection point.

As described above, the communication system according to the fourth embodiment uses a special switch capable of changing a connection destination by changing the reflection direction of light at the reflection point inside the optical switch. Accordingly, in the communication system according to the fourth embodiment, instead of switching the signal path by the optical switch, the user device can be connected to the access network management control unit by modifying the signal path inside the optical switch.

The switching of the signal path by the special optical switch according to the fourth embodiment exemplified in FIG. 9 represents a case in which an influence of a change of a reflection angle at the reflection point can be neglected.

In the above-described configuration, in the communication system according to the fourth embodiment, by setting the reflection point so that light input from a port connected to the user device on the left side of the optical switch is reflected in a direction of the port connected to the access network management control unit, it is possible to execute the signal path normality determination of the signal path of the section between the user device on the left side and the intermediate connection point (reflection point). By setting the reflection point so that light input from a port connected to the user device on the right side of the optical switch is reflected in the direction of the port connected to the access network management control unit, it is possible to execute the signal path normality determination of a signal path of a section between the user device on the right side and the intermediate connection point (reflection point). Accordingly, the communication system according to the fourth embodiment can eliminate a point at which the signal path normality determination cannot be executed, including the section inside the optical switch.

In the communication system according to the fourth embodiment, it is not necessary to modify the signal path between the user device 300-2 on the left side and the intermediate connection point (reflection point) and between the user device 300-1 on the right side and the intermediate connection point. Therefore, in the communication system according to the fourth embodiment, it is not necessary to provide a configuration for modifying the signal path, for example, as in the communication system according to the third embodiment, and an influence of the modifying of the signal path can be neglected.

### Fifth Embodiment

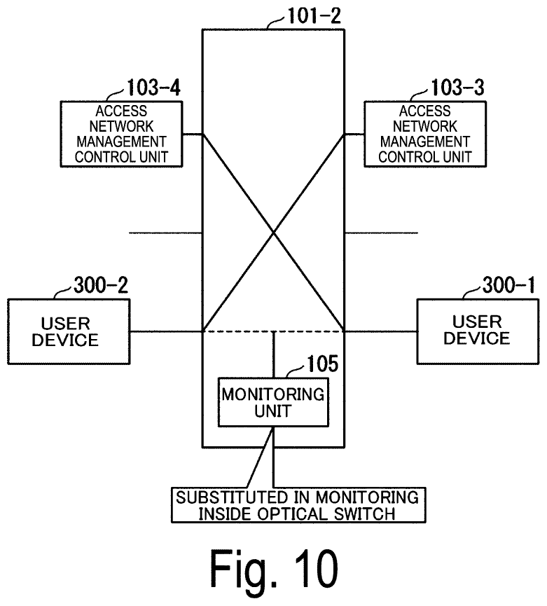

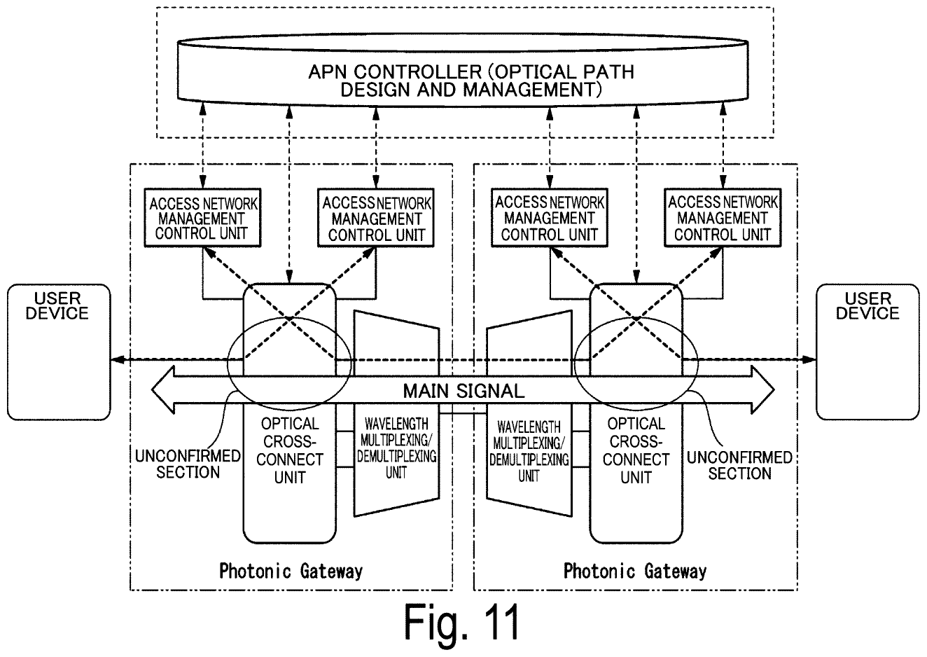

In the communication system according to a fifth embodiment to be described below, as illustrated in FIG. 10, a monitoring unit 105 is provided inside an optical switch. In the communication system according to the fifth embodiment, a monitoring unit in the optical switch by the monitoring unit 105 is replaced by a unit that executes signal path normality determination inside the optical switch using switching or change of a signal path of the communication system in each of the above-described embodiments. The monitoring unit 105 is realized, for example, by providing a dedicated circuit or device inside an optical switch.

In the communication system according to the fifth embodiment, only a signal path inside the optical switch is replaced by a monitoring unit inside the switch. Therefore, another unit that executes signal path normality determination is required for a signal path at a point other than the inside of the optical switch. The other unit that executes the signal path normality determination is, for example, a unit using the above-described return of the signal path, a unit transmitting and responding request information for the above-described transmission confirmation, or a unit transmitting and receiving one-way heartbeat.

As described above, the communication system according to each embodiment of the present invention can prevent generation of a transmission section in which the signal path normality determination cannot be executed in the optical switch in the signal path normality determination.

According to the above-described first embodiments, the communication system includes an optical switch, a splitting/switching unit (a splitter/switcher), and a control unit (a controller). For example, the communication system is the communication system 1 according to an embodiment, the optical switch is the optical cross-connect unit 101-1 and the optical cross-connect unit 101-2 according to the embodiment, the splitting/switching unit is the coupling/splitting unit 400 according to the embodiment, and the control unit is the access network management control units 103-1 to 103-4 according to the embodiment.

The foregoing optical switch is provided in a signal path connecting the first communication device to the second communication device. For example, two user devices are the user devices 300-1 and 300-2 according to the embodiment. The splitting/switching unit is provided outside of the optical switch, splits the optical signal transmitted from the first communication device and passed via the optical switch, transmits one of the split optical signals to the second communication device toward the user device of a transmission source, and transmits the other split optical signal toward the control unit. The control unit terminates the optical signal transmitted from the splitting unit and executes transmission confirmation of the signal path.

According to the above-described second embodiment, the communication system includes an optical switch, a switching unit (a switcher), and a control unit (a controller). The optical switch is provided in a signal path connecting the first communication device to the second communication device. The switching unit disconnects the second user device from the signal path when the transmission of the signal path is confirmed, and switches the signal path so that the optical signal transmitted from the first communication device and passed via the optical switch is transmitted toward the control unit. The control unit terminates the optical signal transmitted by switching the signal path, and confirms the transmission of the signal path.

According to the above-described third embodiment, the communication system includes an optical switch, a switch control unit (a switch controller), and a control unit (a controller). The optical switch is provided in a signal path connecting the first communication device to the second communication device. The switch control unit modifies the signal path inside the optical switch so that the optical signal transmitted from the first communication device is transmitted toward the control unit when the transmission of the signal path is confirmed. The control unit terminates the optical signal transmitted by modifying the signal path, and confirms the transmission of the signal path.

According to the above-described fourth embodiment, the communication system includes an optical switch, a switch control unit (a switch controller), and a control unit (a controller). The optical switch is provided in a signal path connecting the first communication device to the second communication device. The switch control unit switches a reflection direction of an optical signal at a reflection point inside the optical switch so that the optical signal transmitted from the first communication device is transmitted toward the control unit when transmission of the signal path is confirmed. The control unit terminates the optical signal transmitted by switching the reflection direction, and confirms the transmission of the signal path.

According to the above-described fifth embodiment, the communication system includes an optical switch and a control unit (a controller). The optical switch is provided in a signal path connecting the first communication device to the second communication device, and includes a monitoring unit (a monitor) that confirms transmission of the signal path inside the own device and switches a signal path so that an optical signal transmitted from the first communication device is transmitted toward the control unit when transmission is confirmed. For example, the monitoring unit is the monitoring unit 105 according to the embodiment. The control unit terminates the optical signal transmitted from the optical switch and confirms the transmission of the signal path.

In the foregoing communication system, the optical switch divides a section into a section between the communication device and the optical switch, a section inside the optical switch, and a section between the optical switch and another optical switch and executes transmission confirmation.

A part of the communication system according to the above-described embodiment may be realized by a computer. In this case, a program realizing this function may be recorded on a computer-readable recording medium, and the program recorded on the recording medium may be read and executed by the computer system. The “computer system” mentioned herein includes an OS and hardware such as a peripheral device. The “computer-readable recording medium” refers to a portable medium such as a flexible disk, a magneto-optical disc, a ROM, or a CD-ROM or a storage device such as a hard disk built in a computer system. Further, the “computer-readable recording medium” may include a medium that dynamically holds the program for a short time, such as a communication line when the program is transmitted via a network such as the Internet or a communication line such as a telephone line, and a medium that holds the program for a certain period of time, such as a volatile memory inside a computer system serving as a server or a client in that case. The foregoing program may be a program implementing some of the above-described functions, may be a program implemented in a combination of the above-described functions and a program already recorded in a computer system, or may be implemented with a programmable logic device such as a field programmable gate array (FPGA).

Although the embodiments of the present invention have been described in detail with reference to the drawings, a specific configuration is not limited to the embodiments, and design within the scope of the gist of the present invention, and the like are included.

### INDUSTRIAL APPLICABILITY

The present invention is applicable to a communication system executing communication using a communication network such as an all-photonics network (APN).

### REFERENCE SIGNS LIST

1 Communication system
101-1 and 101-2 Optical cross-connect unit
102-1 and 102-2 Wavelength multiplexing/demultiplexing unit
103-1 to 103-4 Access network management control unit
200 APN controller
300-1 and 300-2 User device
400 Coupling/splitting unit

1. A communication system comprising:
an optical switch provided in a signal path connecting a first communication device and a second communication device;
a splitter/switcher disposed outside of the optical switch, configured to split or switch an optical signal transmitted from the first communication device and passed via the optical switch, by splitting the optical signal to the second communication device and the controller when split or by switching toward the second communication device or the controller when switch; and
the controller configured to terminate the optical signal from the splitter/switcher and confirm transmission of the signal path.

212. A communication system comprising:
an optical switch provided in a signal path connecting a first communication device and a second communication device;
a switcher configured to switch the signal path so that a second user device is disconnected from the signal path and an optical signal transmitted from the first communication device and passed via the optical switch is transmitted to a controller-unit when transmission of the signal path is confirmed; and
the controller configured to terminate the optical signal transmitted by switching the signal path and confirm transmission of the signal path.

3. A communication system comprising:
an optical switch provided in a signal path connecting a first communication device and a second communication device, configured to switch an output destination of a signal by modify a path, for transmitting an internal signal, of which one side is fixed to an input/output ports of the switch and the other side is switched to connect to input/output ports of the switch; and
a controller configured to modify the signal paths, terminate the optical signals transmitted and confirm transmission of the both signal paths by modifying the signal path, inside the optical switch, of which one side is fixed to an input/output port connected to the first communication device so that an optical signal transmitted from the first communication device is transmitted toward the controller and by modifying the signal path, inside the optical switch, of which one side is fixed to the input/output port connected to the controller so that an optical signal transmitted from the second communication device is transmitted toward the controller, when transmission of the signal path is confirmed.

4. A communication system comprising:
an optical switch provided in a signal path connecting a first communication device to a second communication device;
a switch controller configured to switch a path of an optical signal at an intermediate connection point inside the optical switch so that the optical signal transmitted from the first communication device is transmitted to a controller when transmission of the signal path is confirmed; and
the controller configured to terminate the optical signal transmitted by switching the path and execute transmission confirmation of the signal path.

5. The communication system according to claim 4,
wherein the intermediate connection point is a reflection point at which the optical signal is reflected, and
wherein the path is a reflection direction of the optical signal at the reflection point.

6. A communication system comprising:
an optical switch including a monitoring unit provided in a signal path connecting a first communication device to a second communication device and confirming transmission of the signal path inside the communication device and configured to switch the signal path so that an optical signal transmitted from the first communication device is transmitted toward a controller; and
the controller configured to terminate the optical signal transmitted from the optical switch and execute transmission confirmation of the signal path, when transmission confirmation is executed.

7. The communication system according to claim 1, wherein the optical switch executes the transmission confirmation by dividing into a section between the communication device and the optical switch, a section inside the optical switch, and a section between the optical switch and another optical switch.

8. A normality determination method comprising:
splitting or switching an optical signal transmitted from a first communication device and passed via an optical switch by a splitter/switcher unit disposed outside of the optical switch provided in a signal path connecting the first communication device or a second communication device, wherein splitting the optical signal to the second communication device and a controller when splitting and switching the optical signal to the second communication device to the controller when switching; and
terminating the optical signal from the splitter/switcher and confirm transmission of the signal path.
